(19) United States
(12) Patent Application Publication
(10) Pub. No.: US 2021/0200595 A1
(43) Pub. Date: Jul. 1, 2021

(54) Autonomous Determination of Characteristic(s) and/or Configuration(s) of a Remote Computing Resource to Inform Operation of an Autonomous System Used to Evaluate Preparedness of an Organization to Attacks or Reconnaissance Effort by Antagonistic Third Parties

(71) Applicant: Randori Inc., Denver, CO (US)

(72) Inventors: David Wolpoff, Denver, CO (US); Eric McIntyre, Vancouver, WA (US); Evan Anderson, Highlands Ranch, CO (US)

(21) Appl. No.: 17/138,593

(22) Filed: Dec. 30, 2020

Related U.S. Application Data
(60) Provisional application No. 62/955,724, filed on Dec. 31, 2019.

(51) Int. Cl. G06F 9/50; G06F 9/48

(52) U.S. Cl. CPC G06F 9/5038; G06F 9/5072; G06F 2209/508; G06F 2209/5011; G06F 9/4881

(57) ABSTRACT

A system and method for performing autonomous analysis of computing resources of a particular organization across the open internet. In particular, a modularized system that is configured to distribute work to ephemeral worker nodes based on constraints associated with individual items of work and based on individual worker nodes. The results of such work can be supplied as input to one or more data detector pipelines that can be independently configured to (1) identify a particular software based on input data probing a remote computing resource and/or (2) suggest human review of probe data to determine whether research and development effort should be applied to determine more information about the remote computing resource.

### CROSS-REFERENCE TO RELATED APPLICATION(S)

This application is a nonprovisional of, and claims the benefit under 35 U.S.C. § 119(e) of, U.S. Provisional Patent Application No. 62/955,724, filed on Dec. 31, 2019, and entitled “Autonomous Determination of Characteristic(s) and/or Configuration(s) of a Remote Computing Resource to Inform Operation of an Autonomous System Used To Evaluate Preparedness of an Organization to Attacks or Reconnaissance Effort by Antagonistic Third Parties,” the content of which is incorporated by reference in its entirety.

### TECHNICAL FIELD

Embodiments described herein relate to computer and network security, and, in particular, to systems of physical and/or virtual machines—interconnected or communicably coupled in a specialized or networked manner—to facilitate autonomous discovery and selective exploitation of one or more computing devices, resources, or networks under the control of a selected organization, or set of selected organizations.

In particular, described herein are systems and methods for evaluating automatically-aggregated electronic reconnaissance data, which may be structured or unstructured data, to predict, with statistical confidence, one or more characteristics or configurations of a remote computing resource (e.g., such as software or hardware type, version, manufacturer, and so on) under the control of a selected organization or set of selected organizations. The predicted/determined characteristics and/or configurations can be used to identify with respect to the remote computing resource: a hardware or software type; a hardware or software major, minor, build, and/or patch version; a manufacturer identity or an author identity; and the like.

### BACKGROUND

A business organization (or government entity) may restrict access to, and control of, a computing device or system by deploying one or more software or hardware security controls configured to prevent unauthorized access by third parties.

Such organizations—especially those outside of network or computer security industries—typically rely on third-party vendors and products to (1) design appropriate security controls, which are often closed source and not subject to inspection or analysis, and (2) to provide periodic analysis verifying whether previously-deployed security controls satisfy industry-standard tests. As an unfortunate result of market forces, an incentive exists for vendors to design security controls primarily to pass industry-standard tests. A parallel incentive exists for vendors and industry professionals to standardize (or otherwise make uniform) suites of tests to be executed against deployed security controls. These facts are often leveraged by antagonistic third parties (including hostile nation states, cause actors, vigilante groups, cyber criminals, and vandals) who continuously, both collectively and independently, research and develop new software, hardware, and social exploit techniques and adapt known techniques for new purposes specifically to circumvent security controls of target organizations in order to cause damage to, and/or exfiltrate information from, those organizations.

As a result, business organizations (and, likewise, data breach insurance agencies) relying on third-party vendors to supply and test security controls often adopt the false impression that deployed third-party security controls are, and will remain, sufficient to prevent all or substantially all attacks or reconnaissance efforts by antagonistic third parties.

### SUMMARY

Embodiments described herein reference systems and methods for receiving and analyzing electronic reconnaissance data to identify, with statistical confidence, one or more characteristics of a remote computing resource, such as a hardware or software version (major, minor, build, patch, and so on), a hardware or software vendor, a hardware or software configuration (e.g., features enabled, disabled, or customized), and so on.

More specifically, embodiments described herein reference systems and methods for receiving and processing results of electronic reconnaissance work (herein, simply, “work”) assigned to, and performed by, individual nodes of a pool of worker nodes. In these examples, each work assigned to each worker node is assigned to obtain information or data describing, or obtained as a result of interacting with, a particular remote computing resource referred to as a “target computing resource.”

The results of completed and failed electronic reconnaissance works (e.g., IP address resolution, MAC address resolution, port scanning, response analysis, response timing, traceroute analysis, nmap analysis, ARP analysis, and so on) are optionally aggregated, normalized, and/or otherwise enriched and are consumed by one or more parallel data analysis pipelines, each comprising a number of discrete data detectors that, in turn, are each independently configured to monitor for specified data, markers, fiducials, or fingerprints (herein, “property-identifying data”) that signal specific information, characteristics, and/or configurations of the target computing resource. Example property-identifying data includes but is not limited to: software or hardware type; software or hardware version (e.g., major, minor, build, patch, and so on); software or hardware manufacturer(s); software or hardware configuration (e.g., features enabled, features disabled, ports open; ports closed; and so on); software or hardware address(es); URLs; domains; subdomains; physical geographic location; service life; uptime; user/root/admin accounts; databases; and so on.

On analysis of one or more property-identifying data, at least one data analysis pipeline can output a computer-readable identification (e.g., JSON, XML, and so on) of a specific characteristic or configuration (more generally, a “property”) of the target computing resource. For example, a computer-readable identification may indicate that the target computing resource is executing Windows XP, Service Pack 1, version 5.1, build 2600.1105. The system can output each computer-readable identification to a “blackbox analysis system,” such as described herein, to inform further reconnaissance operations.

The blackbox analysis system may be a distributed computing system. More particularly, some embodiments described herein take the form of a distributed server system. The distributed computer/server system can include physical servers and/or virtual server instances executing over physical computing hardware. The distributed server system can be configured for assigning a computational task to a worker node instance selected from a pool of worker node instances, the computational task once executed providing output informing remote discovery or remote evaluation of a vulnerability presented by an instance of software executed by a remote computing resource.

In these constructions, as with other embodiments, the distributed server system can include: a memory allocation storing an executable asset and a processor allocation configured to access the executable asset from the memory allocation. The processor allocation can be configured to execute the executable asset to instantiate an instance of a software configured to perform one or more operations, such as described herein.

For example, new reconnaissance works can be assigned that are specifically configured to exfiltrate information from computing devices executing Windows XP, Service Pack 1, version 5.1, build 2600.1105 by exploiting a known weakness or vulnerability of this particular instance of this particular software. Information from subsequent reconnaissance works can inform yet further reconnaissance works, all assigned and selected automatically by the blackbox analysis system. In this manner, in a recursive loop, additional reconnaissance works can be assigned, completed, and the results thereof can be provided as input to the blackbox analysis system.

In some embodiments, a data pipeline, such as described herein, may receive results of electronic reconnaissance works that do not include any property-identifying data, or in other cases, may fail to execute or fail to return affirmative data. In such cases, data can be generated indicating an unexpected result, a null result, or similar. In other case, metadata can be generated. For example, a statistical database may be updated. As one example, a ping operation of a particular target computing resource may fail at certain times of day, but may succeed at other times of day. Systems described herein, which record both successful and unsuccessful results, may be operable to detect pattern that in turn can inform further reconnaissance operations or work assignments.

In yet other examples, a system such as described herein may be configured to record one or more data items, extracts, or other element or data structure obtained from the results of electronic reconnaissance works in a database, datalake, or other structured or unstructured data store. In such examples, the system can periodically analyze the data store to determine whether repetitions of data stored in the data store exist. In such examples, the system may be configured to generate a recommendation or notification, via any suitable user interface such as a graphical user interface, to a data analyst to review the repeated data to determine whether a new data detector can be designed to leverage the repeated data as property-identifying data. In such examples in which a new data detector is designed by the data analyst, the data detector can be added to each data analysis pipeline such that the newly-added data detector can be used to retrieve property-identifying data from newly-received electronic reconnaissance works. In other embodiments, once a new data detector is added to one or more data analysis pipelines, previously-conducted data analysis operations begin again.

In view of these described and other embodiments, more generally and broadly, a blackbox analysis system such as described herein can automatically identify “services” (defined below) and, thereafter, identify “targets” (defined below) associated with a given target organization. In addition, the blackbox analysis system may be configured to automatically suggest to a data analyst one or more new or additional services into which the system recommends to invest research and development work.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A depicts a schematic representation of a system for automated discovery and selective exploitation of computing devices and networks, such as described herein.

FIGS. 1B-1C depict example user interfaces that can be rendered by a client application executed by a client device configured to communicate with a system, such as shown in FIG. 1A.

FIG. 2 depicts another schematic representation of a system, such as described herein.

FIG. 3 depicts another schematic representation of a system, such as described herein.

FIG. 4A depicts a schematic representation of a system, such as described herein, including a secure network of purpose-configured physical and/or virtual machines.

FIG. 4B depicts a block diagram depicting example components of a physical and/or virtual machine, such as described herein.

FIG. 5 depicts a schematic representation of a service detector/enricher, such as described herein.

FIG. 6 depicts a schematic representation of a service detector pipeline of a service detector/enricher, such as depicted and described with reference to FIG. 5.

FIG. 7 depicts a schematic representation of a service suggestor pipeline of a service detector/enricher, such as depicted and described with reference to FIG. 5.

FIG. 8 depicts an example user interface that can be rendered by a client application executed by a client device configured to communicate with a system, such as shown in FIG. 1A, to provide suggestions to a data analyst.

FIG. 9 is a flowchart depicting example operations of a method of operating a service detector, such as described herein.

FIG. 10 is a flowchart depicting example operations of a method of operating a service enricher, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to automated or autonomous systems and methods for (1) obtaining, parsing, processing, and/or aggregating information and/or data related to a specified organization for the purposes of (2) executing arbitrary computer code on one or more computing resources of that specified organization to evaluate one or more network infrastructure defenses or incident response protocols of the organization to attacks to that organization's network or computing infrastructure by antagonistic third parties of differing sophistication, objectives, and skillsets.

As a result of the systems and methods described herein, an organization can readily determine security weaknesses (e.g., information exfiltration, temporary or permanent damage, business interruptions, and so on) that are of most interest to particular categories of both sophistication and/or motivation (e.g., low-sophistication actors, cause-based actors with malicious or destructive intent, corporate or industrial espionage actors, information or identity theft actors, nation states, and so on) of an antagonistic third party.

With such information, an organization can more effectively determine which security weaknesses to address with improved security infrastructure or policy, which security weaknesses to address with additional business insurance, and which security weaknesses to accept as an unlikely or low-priority risk.

For example, a printer with outdated firmware exhibiting a known exploit that is owned and operated by an organization and is not connected to the organization's intranet may be characterized as a low priority security weakness. In this example, if the printer is connected to the organization's network infrastructure but communicates across a dedicated VLAN, the organization may determine that the security weakness introduced by the printer's firmware may be a medium priority. In a further example, if the printer is connected to the organization's infrastructure, the organization may determine that the security weakness introduced by the printer's firmware may be a high priority. These examples are, of course, not exhaustive. An organization can leverage output(s) from a system such as described herein for a number of suitable purposes to improve security, decision-making, and resource allocation.

Embodiments described herein can be configured to autonomously execute attacks and/or to leverage other exploitation techniques to replicate the behavior and decision-making of an antagonistic third party motivated to attack the organization. As a result of these constructions, the systems and methods described herein can quickly, securely, and efficiently identify and triage vulnerable computing resources and services under the control of a target organization that may be particularly appealing to a motivated, supported, and sophisticated antagonistic third party, nation state, or threat actor. With such information, an organization can readily determine which improvements to security infrastructure and/or incident response protocols should be prioritized over others, such as described above.

In many embodiments, in order to effectively replicate the behavior and decision-making of a motivated, antagonistic third party, a system—such as described herein—is configured to operate in a covert, secret, or otherwise undetectable manner in order to avoid detection by the target organization or any vendor or third party that may directly or indirectly protect the target organization from one or more actions of an antagonistic third party.

In many cases, a system such as described herein is configured to operate in a non-damaging or otherwise innocuous manner so as to not cause damage to, or reduce functionality or responsiveness of, any computing or network resource. In addition, in many embodiments, each operation and/or task undertaken by a system described herein can be logged in an auditable manner. Data aggregated by a system such as described herein can be encrypted to protect confidentiality of such information.

In other examples, a system such as described herein may be configured to operate in a readily detectable manner in order to redirect attention of security personnel, information technology professionals, and/or security controls configured to protect or otherwise prevent access to one or more computing or human resources of an organization. For example, in such embodiments, a system such as described herein may be configured to perform a readily-detectable operation (e.g., a port scan, nmap, and so on) to a first computing resource of a target organization while a covert, undetectable, operation is performed to a second computing resource of the same target organization. Such redirection techniques may be suitably performed by a system such as described herein for a number of purposes, as may be appreciated by a person of skill in the art.

Continuing the foregoing description as it relates to operating in a covert/undetected manner, systems and methods described herein are configured to assign discrete items of information-gathering and/or exploitation-execution work (herein, collectively, “jobs”) to individual virtual computing resources (herein, “worker nodes” or “nodes”) selected from a pool of virtual computing resources.

In these embodiments, to avoid detection, each worker node is ephemeral; each node is provisioned on demand, performs one or more jobs in sequence or in parallel, and is thereafter retired and discarded so that if the node were detected performing work, that detection is rendered moot.

In other cases, a computing resource of a target organization (which may be in communication with other computing resources within a private network inaccessible to other nodes in the worker node pool) can be recruited or otherwise exploited to perform work as a worker node available to the pool of worker nodes. In this manner, a detection, if any, of a given worker node does not affect the operation or completion of jobs by any other worker node.

In these embodiments, decisions related to time and/or manner of provisioning, retirement, and/or assignment of jobs to individual worker nodes can be informed based on (1) a constraint schema specific to each individual worker node and (2) based on a constraint schema specific to each job scheduled to be performed. In other words, constraint schemas such as described herein can define for the system which job(s) can be performed by which worker node(s) in a manner that is most likely to avoid detection. As a result, the various information-gathering and/or exploitation-execution works performed by a system, such as described herein, can each be assigned and completed in a job-specific and a worker-specific manner selected to reduce the likelihood that a job will fail, such as by detection, timeout, or any other suitable failure mode.

In addition, as a result of these constructions, computational resources—including, as limited examples, processor cycles, memory, storage, and/or networking connections—associated with or allocated to individual worker nodes can be efficiently and/or optimally utilized at substantially all times. In other words, as a result of the systems and methods described herein, each worker node in a pool of worker nodes can be configured to perform one or more jobs simultaneously, thereby promoting a condition in which each virtual or physical computing resource allocated to each worker node approaches 100% utilization at all times while that worker node is in service (i.e., prior to the worker node being retired). These constructions, as may be appreciated, can reduce the cost(s) associated with operating a system, such as described herein.

As described herein, a constraint schema that may be associated with a particular job or a particular worker node can include any number of suitable “constraints” that limit or otherwise define which specific worker node (or set of worker nodes) can accept and execute a particular job.

Example constraints that may be associated with a job, such as described herein, include, but may not be limited to: a number of execution seconds required to complete the job (e.g., based on averages, profiling, and so on); a minimum amount of free storage required to complete the job; a particular feature, software package, or operating system required to execute the job; a particular network connection type required to execute the job; a particular worker node hardware type required to execute the job; a particular geographic location of a worker node required to execute the job; a particular host service (e.g., cloud service provider) hosting a worker node required to execute the job; a minimum or maximum uptime of a worker node required to execute the job; ability or inability of a worker node to communicate or to send packets to a particular internet protocol (“IP”) address or address range and/or a media access control (“MAC”) address, or using a particular route; a “perspective” of the a given worker node, such as described in greater detail below; operating system permissions level (e.g., user, root, system, guest, and so on); location relative to a known defensive measure (e.g., firewall, traffic filter, and so on); and so on. It may be appreciated that these foregoing examples are not exhaustive.

Example constraints that may be associated with a worker node, such as described herein, include, but may not be limited to: an amount of processor or execution seconds available; an amount of memory available; a geographic location of the worker node; an ability or an inability of the worker node to send packets to a particular IP or MAC address; a physical location of a host service virtualizing the worker node; and so on.

In one specific example, a job such as described herein can include a constraint related to a score corresponding to an amount of “taint” that should be attributed to a worker node that executes and/or completes the job. As used herein, the terms “taint,” “taint score,” “contamination score” and similar phrases refer to a quantity or score associated with a likelihood that performing a particular action would result in being detected by conventional security controls. In this manner, the higher the taint score for a particular job, the more likely that job is to result in a worker node being detected by conventional security controls.

For example, a port scanning job that causes a worker node to scan common TCP or UDP ports (e.g., 80, 8080) of a given IP address at a given interval (which may be randomly adjusted to prevent detection by exhibiting a repeating pattern) may be associated with a low taint score, such as a score of 5 out of 100. In this example, the low taint score indicates that the port scanning operation is unlikely to be detected by a conventional security control. Alternatively, a port scanning job that causes a worker node to scan all ports of a given IP address may be associated with a high taint score, such as 75 out of 100. In this example, the high taint score indicates that the port scanning operation is likely to be detected by a conventional security control.

A taint score can be manually or automatically determined. In some cases, a taint score initial condition is set manually, and then can be adjusted or biased automatically based on, among other things, a frequency at which worker nodes begin failing. In other words, as failure rates increase for particular work, a taint score associated with that work can be accordingly increased.

In these examples and for other embodiments described herein, a taint score can be a constraint associated with a constraint schema for a given job and, additionally, a maximum total taint score can be a constraint associated with a constraint schema for a given worker node. In this manner, and as a result of these constructions, an amount of “taint” can be attributed to a particular worker node based on which jobs that worker node has executed. In other words, for each job executed by a given worker node, the taint score of that worker node can be increased by the amount associated with each new job accepted by the worker node.

In these examples, each worker node can compare its own taint score to a taint score threshold. If the taint of a worker node exceeds or equals the threshold, the worker node can stop accepting new jobs. At a later time, the system can recognize that the worker node has not accepted new work for a threshold period of time and, in response, can retire and discard the worker node. In some embodiments, after a worker node is retired and/or otherwise discarded, a new worker node can be provisioned, although this is not required and new worker nodes can be provisioned at any suitable time.

As a result of these constructions, worker nodes in a pool of worker nodes, such as described herein, can be automatically retired once a given worker node has performed one or more jobs that have a high likelihood of triggering detection by a conventional security control. In this manner, by intentionally setting constraints—and, in particular, constraints associated with a maximum taint of a worker node—a system such as described herein can successfully avoid detection by conventional security controls.

In other words, by adjusting a maximum taint constraint on a system-wide or worker-node-specific basis, a system such as described herein can balance the risk of being detected by a conventional security control with the cost of provisioning and retiring (and/or underutilizing) virtual computing resources.

A person of skill in the art understands that a taint score, such as described herein, can be suitably configured in any implementation to take any suitable value within any suitable range of values. For example, in some embodiments, a taint score for a job and/or a maximum taint score for a worker node can range from 0 to 1. In other embodiments, a taint score for a job and/or a maximum taint score for a worker node can range from 0 to 100. It may be appreciated that the range(s) and/or values associated with taint and/or taint scores are arbitrary and can vary from embodiment to embodiment.

Constraints based on taint scores and/or maximum taint can be variable or fixed or may be calculated in real time. For example, in some embodiments, a taint score may vary based on the time of day at which a job is run (e.g., running the job during business hours is associated with lower taint than executing the same job afterhours).

In some cases, constraints based on taint scores and/or maximum taint can vary based on a perceived sophistication of a given target organization; a sophisticated organization may warrant lower maximum taint scores than an unsophisticated organization. In still other examples, constraints related to taint scores and maximum taint can be based on other constraints associated with a constraint schema. For example, a job's taint score may be increased if executed by a worker node that already has a certain amount of taint.

In still further examples, a single job may have status-dependent taint scores. For example, as a job is executed by the worker node, taint of the worker node may be increased based on an execution stage of the job. For example, initiating a job may be associated with 10 taint and completing the job may be associated with 30 taint. In these examples, if a job fails, the worker node may not be attributed the full taint value (e.g., 40). In other examples, a job-failed status may be associated with a high taint.

It may be appreciated that the foregoing examples are not exhaustive; taint scores and, more generally, constraints or constraint schemas can be leveraged by a system such as described herein to automatically determine where to assign and/or complete work associated with an analysis and/or exploitation of an organization's computational and/or network infrastructure (herein, a “network perimeter”).

Similarly, it may be appreciated that taint scores associated with individual jobs can vary from embodiment to embodiment, from worker node to worker node, from organization to organization, or in any other suitable way. As a result, a system such as described herein can effectively simulate, mimic, and/or otherwise interact with a target organization in a manner that mirrors an antagonistic third party having a particular skillset and/or motivation. For example, taint scores and, more generally, constraints assigned to different work can be changed or adjusted to simulate an antagonistic third party that is easier to detect (e.g., low sophistication, such as a “script kiddie”) or an antagonistic third party that is more difficult to detect (e.g., higher sophistication, such as a red team member or nation state actor).

Similarly, taint scores and/or constraints can be adjusted to simulate an antagonistic third party originating from a particular location (e.g., a constraint on work performed in the system must be performed from an ephemeral node hosted on a cloud provider physically located in a specified geography, such as China or Europe), or an antagonistic third party using a particular toolset or particular attack vector (e.g., using a particular cloud provider or set of cloud providers), and so on. In still further examples, work that is easy to detect (that might ordinarily be scored with high taint) can be intentionally performed in order to divert attention of a target organization's defenses. The foregoing examples are not exhaustive; any suitable modification or implementation-specific setting of taint scores or other constraints can be selected.

As such, for simplicity of description, the embodiments that follow reference implementations in which all worker nodes are constrained by a maximum taint of 100. In these embodiments, a worker node will reject requests to complete work that would cause the taint of the worker node to exceed 100 taint. For example, a worker node having a total taint score (e.g., the sum of taint scores associated with already-accepted and/or already-completed jobs) of 40 will reject a request by the system to complete a job having a taint score of 65, but will accept a request by the system to complete a job having a taint score of 15. In another example, a worker node having a total taint score of 0 will accept a job having a taint score of 100, but thereafter will accept no new jobs. As noted above, once a worker node stops accepting new work, it will be retired either by operation of the worker node itself (e.g., self-retiring) or in response to the system determining that the worker node has not accepted new work for at least a threshold period of time.

In this manner, and as a result of these constructions, “tainted” worker nodes can be automatically retired from the pool of worker nodes, and can be discarded, thereby reducing the likelihood that the system will be detected by one or more conventional security controls.

Further, it may be appreciated that a taint score is merely one example of a constraint, such as described herein. More generally and broadly, it may be appreciated that a worker node will only accept new work if all constraints of both the job and the worker node are satisfied.

As noted above, a system such as described herein can perform a number of tasks in order to effectively replicate the behavior and decision-making of an antagonistic third party. For example, as noted above, a system such as described herein may begin interacting with a “target organization” (or other legal entity, such as a real person or other corporation) by simply collecting and/or otherwise obtaining information related to the network perimeter of the target organization. For simplicity of description, the process or operation associated with obtaining information related to an organization—including mapping that organization's network perimeter—and processing that information into computer-readable or otherwise computer-consumable variables, objects, or other data structure (whether specifically cast or not) is referred to herein as “reconnaissance” of a selected “target organization.”

In a more general phrasing, a system such as described herein is configured to assign one or more tasks that collect information from a targeted computing resource including, but not limited to: addresses, software versions, hardware versions, and so on. Each of these data items can be aggregated to make decisions or determinations, via any suitable statistical matching technique, about a characteristic, configuration, or property of a specified computing resource. More simply, performing electronic reconnaissance can yield raw data that, in turn, can be aggregated to identify a specific “service” (defined below) such as described herein.

Initially, in many embodiments, approval to perform reconnaissance of a particular target organization is provided by the organization itself. For example, an agent of an organization—such as a chief security officer, an information technology officer, or other officer or employee—can access an Internet service, form, or page hosted by a system, such as described herein, to provide input that positively or inferentially identifies the target organization and authorizes the system to covertly or overtly engage with the target organization and/or physical property or human resources under the control of that target organization.

For simplicity of description, the process associated with obtaining permission to engage with a target organization and its assets/resources, including processes related to graphical user interfaces configured to receive input from an agent of the target organization, are referred to herein as operations to “obtain agent authorization.”

Once agent authorization is obtained, a system, such as described herein, can be configured to automatically access any number of suitable databases, data sources, or other resources to obtain information concerning assets of the target organization. Examples can include, but may not be limited to: publicly accessible databases; private or third-party databases; a website of the target organization; social media services or pages; open source intelligence resources; directory services; government databases; domain name system services; and so on. It may be appreciated that the foregoing examples are not exhaustive.

Further, in many embodiments, the system can be configured to obtain information related to computing resources (e.g., servers, clients, networking appliances, information technology appliances, and so on) that the system determines are statistically likely to be under the control of the target organization.

Example information concerning a computing resource that can be obtained by performing a reconnaissance operation, such as described herein, can include but may not be limited to: a domain name; an email address; a virtual host; a subdomain associated with a domain name; a telephone number; an Internet service provider of the associated target organization; a certificate and/or certificate authority associated with a domain name; a browser or device used by an individual associated with the target organization; an IP address or address range and/or a MAC address or address range of a server device, a client device, a hypervisor, a server farm, a cloud service provider, and so on; and the like. It may be appreciated that the foregoing examples are not exhaustive.

Further, in many embodiments, the system can be configured to obtain information related to human resources (e.g., points of contact, current employees, former employees, new hires, vendors, staff, suppliers, clients, and so on) that the system determines are statistically likely to be associated with the target organization.

Example information concerning a human resource that can be obtained by performing a reconnaissance operation, such as described herein, can include, but may not be limited to: an email address; a title; a name; a birthdate; family information; role information; department or organizational responsibility information; social media information; address information; social network information; professional network information; educational background; and the like. It may be appreciated that the foregoing examples are not exhaustive.

Typically, a reconnaissance operation, such as described herein, can be carried out in whole, or in part, via one or more jobs assigned to one or more worker nodes across the open Internet and/or via one or more alternative communication channels, protocols, or services otherwise available to, or accessible by, the public at large (also referred to as “open” resources). For simplicity of description, this constraint is generally referred to herein as conducting reconnaissance of a target organization from a public “perspective.”

As used herein, the term “perspective” is a constraint associated with a particular job and/or a particular worker node and refers to a set of resources, whether those resources are associated with computing resources or human resources, with which a particular worker node can communicate. For example, a computing resource may be a server hosting a website accessible to the open internet.

The server may also be coupled to a private network, not accessible to the open internet, that facilitates communication between the server and a private database. In this example, the server is visible from a public perspective, but the database is not. Instead, the database is visible only from the perspective of the server itself. In this example, a worker node accessing the server from the open internet is constrained to a public perspective and thus cannot accept a job that requires a private perspective with access to the database. A worker node operating on the server itself, however, may be constrained to both a public perspective and a private perspective that includes access to the database.

Additional embodiments described herein reference systems and methods for obtaining information concerning one or more computing resources (defined below) that are determined to be controlled, managed, supervised, operated, leased, owned, affiliated with, or otherwise associated with (herein, for simplicity, “controlled by”), a target organization. For simplicity of description, this process or operation is referred to herein as “resource discovery” or “service discovery.” Herein, service discovery refers to the process of collecting and parsing information relative to particular discovered computing resources of a particular target organization.

For example, service discovery may initiate a set of jobs or work that can return raw data that, in turn, can be parsed to extract discrete data items (e.g., IP addresses, MAC addresses, manufacturer names, version numbers, and so on) that, in turn, can be aggregated together and collectively analyzed to make a prediction that a specific computing resource (e.g., identified by a particular IP address) has particular known configuration(s) or characteristic(s) (e.g., is executing specific software, uses specific hardware). For example, (1) a MAC address data item, which may be extracted from a work performed by a worker node, can be combined with (2) an open port list, which also may be extracted from a work performed by the same or a different worker node, and can be combined with (3) a text response from a computing resource to conclude that the computing resource has hardware manufactured by Cisco executing an NGINX web server, version 1.6.1. The data items can be referred to herein as “property-identifying data.” The system may further infer a hardware version or hardware type of the Cisco hardware based on a latency fingerprint exhibited by the computing resource when responding to requests initiated from one or more worker nodes.

As a result of these determinations that results from the above-described example service discovery operation, the system can instantiate an object or other data structure representation of the computing resource, the data structure including an identifier corresponding to the hardware manufacturer Cisco and an identifier corresponding to the software NGINX web server version 1.6.1. As described in greater detail below, these details can be consumed by the system to determine whether an exploit or other leverage technique exists against either or both the identified hardware or the identified software.

Additional embodiments described herein reference systems and methods for collecting information concerning one or more computing resources that, themselves, cannot be identified or, additionally or alternatively, are not associated with a known exploit or other known reconnaissance benefit (e.g., an ability to pivot to another perspective from the resource, an ability to query another resource from the first resource, an ability to obtain information about another resource from the first resource, and so on). Such collected information can be used at a later time to inform a data analyst of areas that may be of interest for the data analyst to devote research and development time and research.

As a simple example, a system such as described herein may be configured to notify a data analyst that Alpine Linux 4.0.0b1 has been detected on a high number of devices, but that a specific use or leveraging of this type of service is not known to the system at present (e.g., no exploit is known, no additional information is obtainable, and so on). In response, the data analyst may invest time determining whether Alpine Linux 4.0.0b1 can be exploited or otherwise utilized for the benefit of the blackbox analysis system, such as described herein.

In these examples, the system may be configured to present a listing of “suggestions” to the data analyst, after which the data analyst may make a determination of whether to invest resources into leveraging the identified computing device. In some cases, a data analyst may determine that a particular suggestion refers to a particular software that, although common, is known to be difficult to exploit (e.g., maintained by a respected company or developer group). In other cases, a data analyst may determine that a particular suggestion refers to a particular software or hardware computing resource that, although uncommon and very industry specific, is manufactured by a manufacturer known to have lax security. For simplicity of description, such operations attendant to a service discovery operation may be referred to herein as a “service suggestion” or “service enrichment” operation that may be performed by a “service suggestor,” such as described herein.

In some embodiments, suggestions generated by a service suggestor such as described herein may be served as input to a predictive model configured to make a determination of which suggestions are most likely to be acted upon by the data analyst. For example, the predictive model may prioritize or weight importance of certain suggestions based on, without limitation: a number of times a particular piece of collected information has been seen across one or more organizations (optionally filtered or weighted by industry); a software type or hardware purpose (e.g., internet of things devices may be weighted higher than network appliances); a perceived difficulty of developing an exploit (e.g., sophistication of software, prevalence of software, and so on); and so on.

Generally and broadly, as used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control device systems and components thereof (e.g., navigation devices, safety devices or controllers, security devices, and the like); corporate or business infrastructure devices or appliances (e.g., private branch exchange, voice-over internet protocol hosts and controllers, end-user terminals, and the like); personal electronic devices and systems and components thereof (e.g., cellular phones, tablet computers, desktop computers, laptop computers); and so on. It may be appreciated that the foregoing examples are not exhaustive.

Example information concerning a target organization that can be obtained by performing a resource discovery or service discovery operation (the results of which may be used by a service suggestion operation), such as described herein, can include, but may not be limited to: an IP address; a geographic location of an IP address; a computing resource hosting, or otherwise associated with, a webpage or content displayed on or served by a webpage; a computing resource having a particular IP or MAC address; a computing resource having an IP or MAC address within a particular IP or MAC address range; a manufacturer of a specified computing resource; a manufacturer of a network interface card or controller associated with a computing resource; a fingerprint of a computing resource; and the like. It may be appreciated that the foregoing examples are not exhaustive.

In many embodiments, similar to other operations described herein, a resource discovery operation can be carried out in whole, or in part, from a public perspective by assigning one or more jobs to one or more worker nodes selected from a pool of worker nodes. Each of these jobs, as noted above, can be associated with a particular taint score that, in turn, (among other constraints) can inform which worker node executes which job and, additionally, which worker node(s) should be retired and discarded and at what time the retirement should take place. As noted above, once the work/jobs of each worker node is complete, it may be processed, and property-identifying data can be extracted to be used using any suitable method.

Additional embodiments described herein reference systems and methods for obtaining information concerning one or more “services” provided, administered, hosted, or otherwise made available or accessible by (herein, for simplicity, “hosted by”), whether intentionally or unintentionally, a particular computing resource controlled by a target organization.

As used herein, the term “service” refers to a particular version of a hardware-implemented or software-implemented function that performs a known functionality or conforms to a known private or public communication or data transaction protocol. A particular instance of a service on a particular computing resource is referred to herein as an “instantiated service,” a “technical target,” or as a “target.” In some cases, an instance may be associated with an unknown service, but is nevertheless reachable by some communication method. Herein, such a service may be referred to as an “unknown service.”

For example, a particular machine at a particular IP address may have installed a service of “Apache Webserver 2.4.41” determined by, among other works/jobs, submitting a request to a known Apache server admin console of the IP. For example, the system may attempt to submit an HTTP request to port 9990 of the IP address, requesting the URL path “/console.” In other cases, the system may be configured to access a subdomain “admin.*.tld” or other similar common or known addresses likely to point to, or to redirect to, an administration console.

Upon receiving a response, the system may be configured to execute a first regular expression to detect, from the response received from the server, a sequence of three numbers delimited by a period (e.g., “([0-9]{1,4}\.){1,}[0-9]{1,4}”). In addition, the system may be configured to execute a second regular expression to detect the word “Apache” (e.g., “(?i)apache”).

In response to a match of either or both regular expressions, the system can determine that the computing resource responding at the IP address is executing “Apache Webserver 2.4.41.” In these embodiments, property-identifying data can include: the version number; the phrase Apache; and so on. In this example, Apache Webserver 2.4.41 is referred to as the service, the particular machine is referred to as a computing resource of the target organization, and the physical installation of Apache Webserver 2.4.41 onto the particular machine is referred to as the instantiated service or the technical target.

In another example, a particular machine at a particular IP address may have installed a service of “Extron DXP DVI-HDMI 1.18” determined by a number of open ports and accessing an administration panel. In this example, Extron DXP DVI-HDMI 1.18 is referred to as the service, the particular matrix switcher executing that software is referred to as a computing resource of the target organization, and the physical installation of Extron DXP DVI-HDMI 1.18 onto the matrix switcher is referred to as the instantiated service or the technical target.

In view of the foregoing, the process or operation of discovering one or more services that are provided by a particular computing resource is referred to herein as “service discovery” or “service enumeration.” Service discovery/enumeration is described in greater detail below.

In many embodiments, similar to other operations described herein, a service discovery operation can be carried out in whole, or in part, from a public perspective by assigning one or more jobs to one or more worker nodes selected from a pool of worker nodes. Each of these jobs can be associated with a particular taint score that, in turn, (among other constraints) can inform which worker node executes which job and, additionally, which worker node(s) should be retired and discarded and at what time the retirement should take place.

Example electronic reconnaissance information concerning a specified computing resource that can be obtained by performing a service discovery operation, such as described herein, and that can be used to identify a service and/or a target, can include, but may not be limited to: open or closed ports; supported or unsupported communication protocols (e.g., Secure Shell, Telnet, Simple Network Management Protocol, Hypertext Transfer Protocol, Secure Hypertext Transfer Protocol, Real Time Streaming Protocol, Simple Mail Service Protocol, Internet Message Access Protocol, Transmission Control Protocol, User Datagram Protocol, Transport Layer Security Handshake Protocol, and the like); an operating system type, version, vendor, and so on resident on the computing resource; request headers; server software vendor and/or version; enabled server software feature set; Secure Shell banner messages; supported or unsupported encryption; and so on. It may be appreciated that the foregoing examples are not exhaustive.

In these embodiments, the various jobs/works assigned as a result of a service discovery operation produce output of electronic reconnaissance information. In these embodiments, the results of electronic reconnaissance works (e.g., IP address resolution, MAC address resolution, port scanning, response analysis, response timing, traceroute analysis, nmap analysis, ARP analysis, and so on) are optionally aggregated, normalized, and/or otherwise enriched and are consumed by one or more parallel data analysis pipelines, each comprising a number of discrete data detectors that, in turn, are each independently configured to monitor for specified data, markers, fiducials, or fingerprints (herein, as noted above, “property-identifying data”) that signal specific information, characteristics, or configurations of a given computing resource that was the target of the original jobs/works.

Example property-identifying data includes but is not limited to: software or hardware type; software or hardware version (e.g., major, minor, build, patch, and so on); software or hardware manufacturer(s); software or hardware configuration (e.g., features enabled, features disabled, ports open; ports closed; and so on); software or hardware address(es); and so on.

Upon analysis of one or more property-identifying data, at least one data analysis pipeline can output a computer-readable identification (e.g., JSON, XML, and so on) of a specific characteristic or configuration (more generally, a “property”) of the target computing resource. For example, a computer-readable identification may indicate that the target computing resource is executing Windows XP, Service Pack 1, version 5.1, build 2600.1105. Each of these datum (e.g., windows, XP, service pack 1, version 5.1, build 2600.1105) may be considered a property, such as described herein, each of which can be signaled by one or more specific property-identifying data.

In some embodiments as noted above, a data pipeline, such as described herein, may receive results of electronic reconnaissance works that do not include any property-identifying data. In these examples, a system such as described herein may be configured to record one or more data items, extracts, or other element or data structure obtained from the results of electronic reconnaissance works in a database, datalake, or other structured or unstructured data store. In such examples, the system can periodically analyze the data store to determine whether repetitions of data stored in the data store exist.

In such examples, the system may be configured to generate a recommendation or notification, via any suitable user interface such as a graphical user interface, to a data analyst to review the repeated data to determine whether a new data detector can be designed to leverage the repeated data as property-identifying data. In such examples in which a new data detector is designed by the data analyst, the data detector can be added to each data analysis pipeline such that the newly-added data detector can be used to retrieve property-identifying data from newly-received electronic reconnaissance works. In other embodiments, once a new data detector is added to one or more data analysis pipelines, previously-conducted data analysis operations begin again.

In view of these described and other embodiments, more generally and broadly, a blackbox analysis system such as described herein can automatically identify “services” (defined below) and, thereafter, identify “targets” (defined below) associated with a given target organization. In addition, the blackbox analysis system may be configured to automatically suggest to a data analyst one or more new or additional services into which the system recommends to invest research and development work.

Additional embodiments described herein reference systems and methods configured to automatically perform a heuristic analysis of one or more discovered services of a particular computing resource (and/or capabilities of a human resource) in order to tag, categorize, organize, score, value, grade, sort, and/or prioritize those discovered services based on a predicted appeal of each service to the attention of an antagonistic third party, also referred to as a “threat agent.” For simplicity of description, this process or operation is referred to herein as “appeal scoring” or “temptation scoring” based on an “appeal heuristic.”

In these examples, a system such as described herein can be configured to evaluate whether any instantiated service of any discovered computing resource of a target organization is vulnerable to a publicly-known or privately-known exploitation technique.

In other words, systems described herein are configured to autonomously evaluate whether an instantiated service of a computing resource of a particular target organization includes, or is likely to include, a “vulnerability.” This term is used herein to refer to a potential security weakness of a particular computing resource that may be leveraged using a publicly or privately known “exploit” to execute arbitrary computer program code on that computing resource. Similarly, systems described herein can be configured to evaluate whether any human resource of a target organization is susceptible to be “induced” or “recruited” to, voluntarily or unknowingly, perform one or more tasks on behalf of the system. (e.g., phishing, whaling, and so on).

Examples concerning an appeal scoring operation, such as described herein, can include, but may not be limited to: increasing an appeal score upon determining that a discovered service exhibits a vulnerability that can be exploited by a publicly or privately known method; decreasing an appeal score upon determining that a discovered service does not exhibit a publicly or privately known vulnerability; increasing an appeal score upon determining that a discovered service or a discovered computing resource is likely to be communicably coupled to a database or another computing resource; decreasing an appeal score upon determining that a discovered service or a discovered computing resource is likely supported by a control, such as a firewall or intrusion detection apparatus; increasing an appeal score upon determining that a discovered service or a discovered computing resource is likely used to store, to be able to obtain, and/or to gate access to confidential information and/or real or personal property; increasing an appeal score upon determining that a discovered service is presented in a particular manner typically associated with an unsophisticated implementation (e.g., a web page presented without aesthetic styling, a manually coded or edited web page, a web page presented without mobile device rendering support, and the like); and so on. It may be appreciated that the foregoing examples are not exhaustive.

Further examples concerning an appeal scoring operation, such as described herein, can include, but may not be limited to: increasing an appeal score upon determining that a human resource is a member of a group of employees in a particular department of a target organization (e.g., marketing, human resources, information technology, legal, engineering, maintenance, and so on); changing an appeal score upon determining that a human resource is an executive of a target organization; changing an appeal score upon determining that a human resource is a contactor of a target organization; increasing an appeal score upon determining that a human resource uses a particular email address or username in one or more publicly-accessible forums; increasing an appeal score upon determining that a human resource is likely to be responsive to an email or telephone call from an unknown third party; and so on.

In many embodiments, an appeal scoring operation—whether associated with a computing or human resource—can be carried out in whole, or in part, from a public perspective.

Additional embodiments described herein reference systems and methods configured to automatically (or in response to an instruction from an agent of a target organization) execute an exploit of a vulnerability—whether publicly known or privately known and undisclosed—of an instantiated service of a particular computing resource to cause that computing resource to exhibit unintended behavior. As with other embodiments, the execution of an exploit of a given instantiated service of a given computing resource may be associated with a particular taint score.

Still further embodiments described herein reference systems and methods configured to automatically execute a task to recruit a human resource of a target organization to induce the human resource to perform an unintended task. As with other embodiments, such an operation may be associated with a particular taint score.

Examples of unintended behavior of a computing resource that can be caused by executing an exploit of a privately-known or publicly-known vulnerability and/or by leveraging a human resource to gain access to said computing resource include, but are not limited to: executing arbitrary computer program code or instructions; transferring or communicating data; writing data to volatile or non-volatile memory; discontinuing one or more services hosted by the computing resource; communicably coupling to, or decoupling from, another system or computing resource; shutting down; restarting; operating outside of ordinary parameters (e.g., over- or under-clocking, operating under high-temperature conditions, and the like), and so on. It may be appreciated that the foregoing examples are not exhaustive.

For simplicity of description, a computing resource with an instantiated service that has been successfully exploited (e.g., by delivering an “exploit” to that computing resource) is referred to as a “compromised computing resource.”

Similarly, a human resources that can or may be recruited or induced—whether knowingly, unknowingly, or otherwise—to perform a task is referred to herein as a “compromised human resource.”

For further simplicity, many embodiments that follow reference only compromised computing resources but it may be appreciated that this is merely one example and that other embodiments described herein can equivalently apply to leverage compromised human resources as well. As such, it may be understood that use of the phrase “compromised resource” can equivalently apply to either or both compromised human resources or compromised computing resources.

For example, some embodiments described herein reference systems and methods configured to automatically search, mine, and/or otherwise examine a compromised computing resource for information that may inform other decisions of the system, such as other computing resources to attempt to compromise. Example information can include, but may not be limited to: personal identification information (e.g., names, social security numbers, telephone numbers, email addresses, physical addresses, driver's license information, passport numbers, and so on); identity documents (e.g., drivers licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

Similarly, some embodiments described herein reference systems and methods configured to automatically search, mine, and/or otherwise examine a compromised human resource for information. Examples include, but are not limited to: social media information; name information; email address information; recent email correspondence; recent message correspondence; recently accessed files; recently placed telephone calls; and so on. It may be appreciated that the foregoing examples are not exhaustive.

For simplicity of description, the foregoing example operations and processes are referred to herein as “mining” of a compromised resource. As with other embodiments, the operation of mining of a compromised resource may be associated with a particular taint score.

In some examples, mining a compromised computing resource of a target organization may reveal an additional service provided by the compromised computing resource that may be vulnerable to another exploitation. In other examples, mining a compromised computing resource may reveal one or more additional or previously unknown computing resources that are communicably coupled to the compromised computing resource (e.g., computing resources not discoverable from a public perspective). Similarly, mining a compromised human resource may reveal one or more capabilities of that resource.

Accordingly, additional embodiments described herein reference systems and methods configured to recursively perform additional and/or supplemental reconnaissance, resource discovery, service discovery, appeal scoring, exploitation, and mining of compromised computing and human resources from the perspective of previously-compromised computing resources. As may be appreciated, and as noted above, a compromised computing resource may be communicably coupled to one or more additional computing resources or services that are not themselves discoverable from a public perspective. For simplicity of description, this process or operation is referred to herein as “perspective pivoting.” In many embodiments, the operation of perspective pivoting on a particular compromised computing resource may be associated with a particular taint score.

Collectively, and for simplicity of description, the recursive execution of the operations of reconnaissance, resource discovery, service discovery, service suggestion, appeal scoring, exploitation, mining, and perspective pivoting—whether performed in a breadth-first manner, a depth-first manner, or in any other suitable manner or order—is referred to herein as an ongoing “blackbox analysis” of a target organization.

As used herein, the phrase “blackbox analysis” refers to any of a set of operations performed to obtain information about, or from, a target organization. Such information can include, without limitation: information about computing resources owned, operated, leased or otherwise under the permissioned control authority of the organization or an agent of the organization; information about a network boundary separating the open Internet from a private network owned, operated, leased or otherwise under the permissioned control authority of the organization or an agent of the organization; determining an identity of and/or information about an employee, officer, or agent of the organization; and so on.

In many embodiments, the tasks associated with a blackbox analysis of a target organization are automatically performed by a system, such as described herein. To perform these operations, as noted above, a system, such as described herein, is configured to segment tasks to be performed in the course of a blackbox analysis into discrete activities (referred to herein as “plans”) that are defined by one or more sets of discrete assignments of work (as noted above, referred to herein as “jobs”) to execute specific items of computational “work.”

In this manner, by splitting each task associated with a blackbox analysis into discrete items of computational work to be performed, such work can be assigned to, and executed by, any suitable computing device in communication with, or under the control of, the system including worker nodes, such as described above.

More specifically, in many embodiments, a system—such as described herein—maintains a rotating pool of temporary or ephemeral virtual machines (“worker nodes”), hosted by one or more virtual computing environments. The term “virtual computing environment,” as used herein, refers to any system, technique, or architecture implemented to distribute access to shared physical hardware resources (e.g., processors, memory, network connections, and so on) among one or more instances of one or more “virtual machines” or “containers” that may be freely instantiated (herein, “provisioned”) and decommissioned (herein, “retired”).

As such, it may be appreciated that a virtual computing environment may refer to any suitable known or later-developed technique, design, or architecture for hardware virtualization, network virtualization, storage virtualization, memory virtualization, containerization, and/or any combination thereof whether such virtualization or containerization is configured to aggregate multiple physical hardware resources into a single virtual machine or container and/or is configured to distribute access to physical hardware resources among multiple virtual machines or containers. In many cases, such an architecture is referred to as a “distributed work” architecture.

In some embodiments, a pool of worker nodes can include physical machines in addition to ephemeral machines. For example, as noted above, a compromised resource can be treated by the system as a worker node, having constraints (which can include a perspective) different from one or more of the ephemeral worker nodes.

In these embodiments, each worker node is configured to receive and execute jobs assigned by the system. As noted above, work can be related to any task or operation of a system, such as described herein, including but not limited to: reconnaissance, computing and human resource discovery, service and capability discovery, appeal scoring, exploitation and recruitment, mining, and perspective pivoting (which may include tunneling or otherwise connecting to or through a compromised resource).

Once a job assigned to a particular worker node is complete, that worker node can announce via a suitable protocol, such as a secure announce-fetch communication protocol (e.g., Rabbit MQ) or subscription protocol (e.g., MQTT), or another message queue protocol, that a job having a particular job identifier is complete.

Thereafter, the system can fetch the results of the job from the worker node and can store those results in a database or other data store. Thereafter, the worker node can continue to accept new jobs that satisfy the constraints of the worker node. If no new jobs satisfy the constraints of the worker node (including, as one example, a maximum taint score), the worker node can be retired and, optionally, a new worker node can be provisioned.

In this manner, the system can perform all computational work associated with a blackbox analysis of a target organization in a covert manner. More specifically, the system can avoid detection because discrete items of computational work are performed by separate, distinct, and/or ephemeral machines not readily associable with the system itself. In other words, even if a single worker node is detected and/or blocked by a target organization or a third party, the computational work of a blackbox analysis—such as described herein—can continue by automatically assigning the work previously assigned to the detected worker node to a new worker node.

Additional embodiments described herein reference systems and methods to schedule the assignment and execution of computational work, associated with a particular blackbox analysis of a particular target organization, to one or more worker nodes. In these examples, the execution and creation of plans and/or jobs can be managed by assigning associated computational work to each node in a pool of worker nodes in a sequential or round robin manner. If a given worker node rejects a job (e.g., due to the job not satisfying the constraints of the worker node), the job can return to a job queue to be assigned to another worker node. However, it may be appreciated that this architecture is merely one example, and work can be assigned to worker nodes in a pool of worker nodes in any other suitable manner.

In still further examples, a system or method such as described herein can be configured to generate new plans and/or jobs to be completed in the course of a blackbox analysis of a particular target organization, after computational work from a previously assigned plan or job completes.

For example, in one embodiment, work associated with a reconnaissance operation can include subdomain enumeration. Once one or more subdomains of a domain name of the target organization have been discovered via computational work associated with a reconnaissance operation, a system such as described herein can be configured to automatically generate a plan and/or one or more jobs to perform a resource discovery operation based on the subdomain information or data.

For example, a resource discovery plan may include a job to perform the computational work of resolving a particular subdomain to an IP address (with may be associated with a particular taint score) and, thereafter, a job to perform the computational work of service discovery by determining a hardware manufacturer and/or software vendor of a physical or virtual machine associated with the discovered IP address, and so on (which may be associated with the same or a different taint score). As noted with respect to other embodiments described herein, the system may be further configured to provide service recommendations to a data analyst in order to encourage the data analyst to research new means of identifying hardware and/or software exploits or other information leverage techniques. Such systems, in further embodiments, can be configured to aggregate data retrieved from multiple discrete computing resources in order to inform decision-making regarding the assignment of work and/or the execution of one or more resource and/or service discovery operations.

For example, if it is determined that all computing resources discovered to date of a particular organization are manufactured by Cisco, a discovered device of unknown manufacture may be presumed to be manufactured by Cisco. In another example, if it is determined that substantially all computing resources discovered to date of a particular organization are manufactured by Ubiquiti, and all other devices are manufactured by Dell, it may be determined that a discovered device that exhibits features of a Huawei appliance may trigger additional verification steps to increase confidence that the discovered device is actually manufactured by Huawei. It may be appreciated that these examples are not exhaustive; other information aggregation or use techniques may be considered in further embodiments.

In this manner, a system, such as described herein, can automatically and recursively create plans, jobs, and assignments of computational work to perform a blackbox analysis of a particular target organization, while simultaneously leveraging all available information to suggest focus of future research and development efforts, without the system exposing itself to potential detection by the target organization or by a third party.

Additional embodiments described herein reference systems and methods for securely processing and sharing data while performing a blackbox analysis of a particular target organization. More specifically, in many implementations, a system, such as described herein, includes a number of purpose-configured physical and/or virtual machines (referred to herein as “service managers”), each tasked with a particular function or set of functions.

In many cases, such an architecture is often referred to as a “modularized” or “microservices” system architecture, operating according to event-driven protocols. It may be appreciated that a modularized system architecture can be scalable (due, in part, to defined application programming interfaces between discrete system managers or modules) and secure and stable (due, in part, to isolation of features and functions). Similarly, it may be appreciated that although an event-driven system architecture is described herein, monolithic systems can perform many if not all operations described herein.

For example, a first service manager may be configured to fetch results from worker nodes that have announced completion of work (e.g., generated an event received by an event queue, items of which are consumed by the first service manager). A second service manager may be configured to receive information or data obtained by the first service manager and process, format, validate, or otherwise manipulate that received information or data. A third service manager may be configured to receive formatted information or data from the second service manager to perform an appeal scoring operation based on an appeal heuristic.

In these examples, communication between each service manager can be encrypted and secure. In this manner, and as a result of this construction, different operations and/or service managers of a system, such as described herein, can be performed with different permissions in order to increase the security of information received, manipulated, analyzed, and/or stored by the system. As a result of this construction, if one or more service managers are compromised, access to information stored by or accessible to other service managers may be automatically and quickly disabled.

Additional embodiments described herein reference systems and methods for securely storing data while performing a blackbox analysis of a particular target organization. More specifically, in many implementations, a system, such as described herein, includes a number of purpose-configured physical and/or virtual machines configured to securely store data collected and/or aggregated in the course of a blackbox analysis. In some cases, such data can include data or information exfiltrated from a compromised computing resource of a target organization, such as documents, text data, image data, data obtained as a result of a perspective pivot, and so on. In these examples, data and/or information owned by and/or created by the target organization can be stored in an encrypted database such that the data is only accessible to and viewable by an agent of the target organization. In this manner, a system, such as described herein, can securely receive, analyze, and store data while performing a blackbox analysis of a particular target organization without exposing data associated with that target organization to any third party, service, or threat actor.

In view of the foregoing, it may be understood that generally and broadly, described herein is an autonomous modularized system configured to distribute work to worker nodes, which may accept or reject such work based on constraints (including taint scores) associated with each job and each worker node, in order to perform a blackbox analysis of a target organization, that can quickly, securely, and efficiently identify and triage vulnerable computing and human resources and services under the control of that target organization that may be particularly appealing to a motivated, supported, and sophisticated antagonistic third party, nation state, or threat actor. In addition, the blackbox analysis system can monitor for and suggest new services and/or targets to a data analyst to research.

More generally, embodiments described herein can be implemented and/or architected as distributed computing systems of communicably interconnected instances of software. Each instances of software instantiated in a system as described herein may execute over one or more computing resources or resource allocations virtualized over other computing resources. For simplicity of illustration, each instance of software can execute as a result of a processor (allocation), whether physical or virtual, accessing a data store (allocation) or other persistent memory structure to retrieve an executable asset. The asset may be compile computer code, may be un-compiled computer code, may be a binary file, and so on; these examples are not exhaustive. The processor (allocation) can load at least a portion of the executable asset into a working memory communicably interconnected with the processor allocation. This process may cause to be instantiated a purpose configured instance of software configured, in turn, to communicate with other instances of similarly-instantiated software located elsewhere in the system. Example instances of software described herein can include, but are not limited to: worker node instances; service manager instances; service discovery instances; taint scoring instances; work assignment instances; blackbox analysis instances; data pipelines; and so on. More generally and broadly, it may be appreciated that any reference provided herein to a discrete operation of a portion of a system as described herein may be understood to be carried out in whole or in part by an instance of software executing over a processor allocation and a memory allocation.

As a result of these described systems and methods, an organization—or an authorized agent of an organization—can quickly and efficiently identify, prioritize, and neutralize vulnerabilities of interest to antagonistic third parties or threat actors. In addition, the organization can quickly and efficiently identify gaps in knowledge, training, or expertise that may have caused or assisted one or more vulnerabilities to exist.

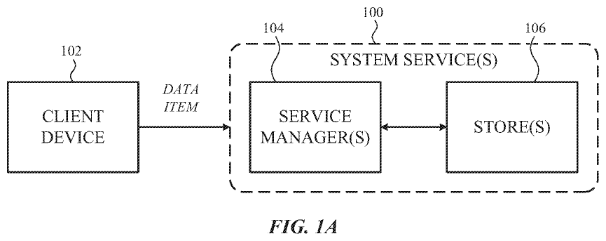

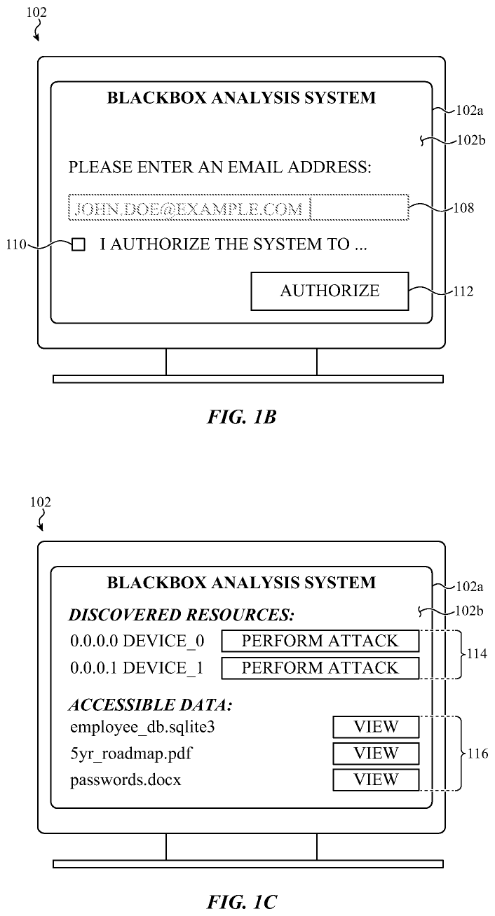

These foregoing and other embodiments are discussed below with reference to FIGS. 1A-10. However, those skilled in the art will readily appreciate that the detailed description given herein with respect to these figures is for explanation only and should not be construed as limiting.

In particular, FIG. 1A depicts a simplified schematic representation of a blackbox analysis system 100, such as described herein, that is configured to perform a blackbox analysis of a selected target organization.

For simplicity of description and illustration, the embodiments that follow refer to a corporation as an example of a target organization and an officer of that corporation (e.g., a chief information security officer) as an agent of that corporation, although it may be appreciated that these are merely isolated examples. In other cases, other entities can be targeted including, but not limited to: government agencies or offices; partnerships or firms; universities and other educational institutions; medical institutions; research institutions; individuals; utilities; and so on.

In the illustrated embodiment, the blackbox analysis system 100 implements, in part in some embodiments, a client-server architecture to facilitate communication with an agent of the organization. More specifically, the blackbox analysis system 100 can include, or can be communicably coupled to, a physical or virtual server—or more than one physical or virtual servers—configured to host an Internet-accessible service.

As a result of the client-server architecture, an agent of an organization can operate an arbitrary Internet-connected device (e.g., laptop, tablet, desktop computer, cellular phone, and so on) connected to the Internet-accessible service to provide input to, and to receive information from, the blackbox analysis system 100. An example device that can be operated by an agent of a target organization, such as described herein, is shown in FIGS. 1A and 1s identified as the client device 102.

As noted with respect to other embodiments described herein, the blackbox analysis system 100 may be configured to autonomously perform a blackbox analysis of a target organization if and only if an agent of the target organization has provided clear and express instructions and authorization to do so. In the illustrated example, the client device 102 can be operated by an agent of a target organization to communicate an authorization to perform a blackbox analysis of the organization that the agent represents.

The client device 102 can be configured to communicably couple to the Internet-accessible service hosted by the blackbox analysis system 100 in any suitable manner. For example, with reference with FIG. 1B, in some embodiments, the client device 102 can execute an instance of an application (e.g., native application, browser application, and so on) configured to securely or otherwise communicably couple to the Internet-accessible service hosted by the blackbox analysis system 100. More specifically, the client device 102 can include a housing that encloses a display 102a that provides a visual or graphical user interface 102b with which a user can interact. In this illustrated example, a user of the client device 102—such as an agent of the target organization—can be presented with a request to enter information that identifies or can be used by the blackbox analysis system 100 to identify the target organization. In the illustrated example, the agent is asked to input an email address into an input box 108. The email address provided by the agent can be associated with a target organization based on the domain name of the email address. The graphical user interface 102b also can include an authorization or informed consent checkbox 110 that must be selected by the agent to indicate that the agent authorizes the blackbox analysis system 100 to begin analysis of the target organization. In many examples, a detailed description of the tasks that the blackbox analysis system 100 may undertake may be provided nearby the informed consent checkbox 110. In some cases, a detailed description can be accessed by the agent by clicking a link rendered adjacent to or otherwise nearby the informed consent checkbox 110.

Once the agent has reviewed the detailed description and/or reviewed any other suitable documents required to authorize the blackbox analysis system 100 to interact with the target organization, the agent may click a submit button 112 to complete the authorization process and to signal the blackbox analysis system 100 to initiate one or more operations to perform a blackbox analysis of the target organization.

In some cases, the blackbox analysis system 100 can be configured to send a confirmation email to the email address provided by the agent to verify that the email address is a genuine email address. In still other examples, the blackbox analysis system 100 may require two-factor authentication before initiating any blackbox analysis operation.

In other cases, an input such as an email address may not be required of the agent. For example, in some implementations the blackbox analysis system 100 implements an OAuth 2.0 (or other) service that merely requires the agent to authorize the blackbox analysis system 100 to access one or more social media or email credentials of the agent.

The foregoing examples are not exhaustive; in other embodiments, other information can be presented in the client application on the client device 102 to solicit other input from the agent. Examples include, but are not limited to: presenting a drop-down menu including one or more selectable target organizations; presenting an input box to type a name of a target organization; presenting a document or photo upload function that, once processed (e.g., passed through optical character recognition and/or other preprocessing or post-processing steps or stages) can be parsed to determine a target organization; presenting a geolocation feature to select the target organization based on the physical location of the agent and/or the client device 102; and so on. These examples are not exhaustive; any suitable information can be provided.

Similarly, the authorization to perform a blackbox analysis of a target organization can be communicated from the client device 102 to the blackbox analysis system 100 in any suitable form or format including, but not limited to: a completed web form; a photograph of the representative; biometric information of the representative; an identity document of the representative; a name of the representative; a credential or login of the representative; and so on. Typically the authorization, along with any information communicated with the authorization, such as an identification of the target organization, is encrypted, encoded, or otherwise secured. In other cases, however, this may not be required and it may be appreciated that encryption may not be specifically required of all embodiments.

Returning to FIG. 1A, once the authorization and identification of a target organization has been received by the blackbox analysis system 100, a blackbox analysis can begin. As noted above, a blackbox analysis of a target organization typically consists of numerous discrete tasks that can be performed, in whole or in part, by one or more service managers or data stores. Example service managers are represented in FIG. 1A and identified as the service managers 104. Similarly, example data stores are represented in FIG. 1A and identified as the data stores 106.

The service managers 104 and the data stores 106 of the blackbox analysis system 100 can cooperate to perform or coordinate one or more operations or tasks associated with a blackbox analysis of the identified or selected target organization. Such tasks, as noted above, can include, without limitation or express requirement, reconnaissance, resource discovery, service discovery, service suggestion, appeal scoring, exploitation, mining, and perspective pivoting.

These operations can be performed in sequence or, in some cases, simultaneously or contemporaneously. In addition, and as noted above, completion of one task or operation—or, more specifically, completion of a plan or a job—each of which may be associated with a particular taint score and/or other constraints defined in a job-specific constraint schema—associated with a particular task or operation—can trigger another task or operation. In this manner, and as noted with respect to other embodiments described herein, the blackbox analysis system 100 can perform the various operations associated with a blackbox analysis recursively.

As with other embodiments described herein, jobs scheduled by one or more of the service managers 104 may be performed, in whole or in part, by a selected worker node in a pool of worker nodes (not shown). The worker nodes of the pool of worker nodes may be configured to accept and/or reject jobs based on constraints and/or other requirements specific to each individual worker node. In particular, each worker node may be configured to only accept work that does not elevate its own taint score above a maximum taint score threshold. In one example, the maximum taint score is a unit-less value of 100. In these embodiments, worker nodes that continue to reject jobs as a result of a taint score fault may be, after a threshold time has passed, retired.

The service mangers 104 and the data stores 106 of the blackbox analysis system 100 can be implemented in any suitable manner. In many embodiments, each of the service managers 104 and the data stores 106 include one or more physical servers, network appliances, and/or storage appliances (each of which may include, without limitation: a processor; memory; storage; network connections; and so on) or, additionally or alternatively, include a virtual server or container, that is virtualized or containerized—in whole or in part—in a virtual computing environment. In some cases, the blackbox analysis system 100 can be implemented, in whole or in part, as a cloud service operating on an arbitrary number of physical servers that may or may not be geographically distributed. In still further examples, the blackbox analysis system 100 can be operated, in whole or in part, in a serverless virtual computing environment.

Once a blackbox analysis has been performed by the blackbox analysis system 100, results of said analysis can be transmitted or otherwise communicated back to the client device 102 for review by the agent or another user thereof. For example, FIG. 1C depicts an example user interface that can be rendered by a client application executed by a processor of the client device 102. In this example, a select set of results of the blackbox analysis are displayed to the user of the client device 102. In many cases, the results shown to the user/agent are results exhibiting the highest appeal score, described in greater detail below. In the illustrated example, the blackbox analysis system 100 presents, via the graphical user interface 102b, specific exploitable resources that were discovered as a result of a resource discovery operation and/or as a result of a service discovery operation. In the illustrated embodiment, two discovered resources are shown, each of which has been determined by the blackbox analysis system 100 as being potentially exploitable using a publicly or privately known exploit. In this embodiment, the agent of the target organization can be presented with a second authorization option 114 that gives the agent the option to authorize an attack to one or more of the discovered resources.

In addition, in the illustrated embodiment, three recovered data items of high interest are shown to the agent via the graphical user interface 102b. In particular, a database that may contain employee information is shown, a document that may contain trade secrets of confidential business information is shown, and a document that may contain one or more passwords is shown. In this embodiment, the agent of the target organization can be presented with an option 116 to view these documents to verify the authenticity of the exfiltrated data.

As noted above and in particular with reference to FIG. 1B, the example graphical user interface shown in FIG. 1C is not exhaustive. It may be appreciated that any number of suitable data items and/or other information can be shown to a user of the client device 102. These data items can be presented in any suitable form or format. In some cases, the form or format of presentation of data may depend upon, without limitation: the target organization; a confidentiality score or judgment performed by a service manager of the blackbox analysis system 100 (e.g., highly sensitive documents may be presented in a redacted form); the agent; and so on. As such, generally and broadly, it is appreciated that an example user interface such as shown in FIGS. 1B-1C can be modified or designed to display any suitable data, graphic, chart, text summary, warning or informational notification, and so on.

Similarly, it may be appreciated that although the client device 102 is depicted as a computing device, this is not required; a client device can be any suitable portable or stationary electronic device capable of communication with one or more services hosted by the blackbox analysis system 100 or a system or subsystem thereof. Example electronic devices that can communicably couple to the blackbox analysis system 100, such as described herein, include but are not limited to: laptop computers; desktop computers; tablet computers; cell phones; and so on.

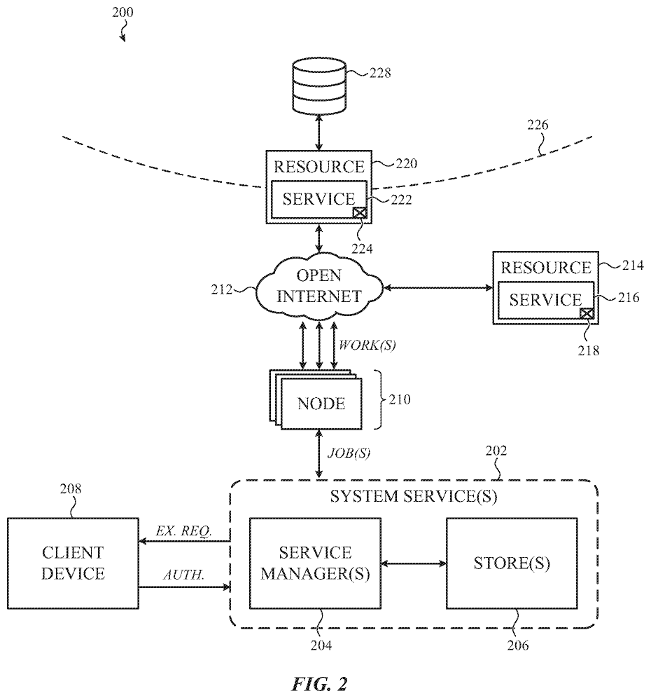

FIG. 2 depicts another schematic representation 200 of a blackbox analysis system 202, such as described herein. In particular, as with the embodiment depicted in FIG. 1A, the blackbox analysis system 202 includes one or more service managers 204 and one or more data stores 206 that are configured to communicate with one another and with a client device 208 that can be operated by a representative of a target organization, such as described herein.

After receiving an authorization from the client device 208, the blackbox analysis system 202 and, more specifically, one or more of the service managers 204 and the data stores 206 can cooperate to autonomously perform a blackbox analysis of an identified target organization.

In one example, a first service manager of the service managers 204 may begin the blackbox analysis of the target organization by triggering or scheduling a reconnaissance operation based on information received from the client device 208 by the blackbox analysis system 202. For example, as noted above, the representative of the target organization may provide an email address.

In this example, the first service manager may be configured to perform or schedule a job to perform computational work to abstract a hostname from the email address supplied by the client device 208. In this manner, the first service manager obtains a hostname known to be directly associated with the target organization. In some embodiments, the first service manager can assign a “confidence score” or other statistical value to the hostname extracted from the email address supplied by the client device 208.

The confidence score corresponds to a judgement of whether the hostname is actually under the control of the identified target organization. The confidence score can fall within a range from a minimum to a maximum (e.g., 0 to 100 or 0 to 255), although this is not required. In this example, because the hostname was extracted directly from user-supplied content (e.g., organization-supplied content), the first service manager can assign a high confidence score, such as 100 or 255.

It may be appreciated, however, that a definition of a “high” confidence score may vary from embodiment to embodiment or implementation to implementation. In some cases, a confidence score of 50 out of 100 may be considered “high” whereas, in other cases, a confidence score of 10 out of 100 may be considered “high.” As such, generally and broadly, it may be appreciated that a “high” confidence score as contemplated herein is a score, vector, matrix, or other data structure or mathematical construct having a value or magnitude that, for a given implementation or construction, is statistically more significant (e.g., satisfying a fixed or adjustable threshold) than other values in a given set of values.

Continuing the preceding example, after being assigned a suitably high confidence score by the first service manager, the hostname can be stored in one or more databases of the data stores 206 and can be tagged and/or categorized as a high-confidence data item. In other words, the blackbox analysis system 202 can treat the hostname as high-value data because the origin of that data is verified or otherwise known to be associated with the target organization.

In response to obtaining and/or storing a hostname associated with the target organization, the first service manager—or, in other embodiments, another service manager of the service managers 204—can be configured to develop or retrieve a plan to investigate and/or analyze that hostname (e.g., reconnaissance).

For example, in some embodiments, a pre-configured plan file, template, schema, or configuration can be stored in one or more databases of the data stores 206, or in a remote database accessible to the blackbox analysis system 202. In other embodiments, a plan for investigating a hostname may be assembled or created on demand by one or more of the service managers 204. For simplicity of description, the embodiments that follow reference an implementation in which one or more plan templates are stored in a database of the data stores 206.

Continuing the preceding example, the first service manager—or, in other embodiments, a second service manager of the service managers 204—can be configured to schedule one or more jobs associated with a selected plan or plan template for performing a reconnaissance operation and, in particular, for obtaining information related to the known hostname. More particularly, the various jobs associated with a selected plan can be enqueued in a job queue which can then be submitted individually or in groups to one or more worker nodes, discussed in greater detail below. In particular, each of the worker nodes may compare constraints associated with a particular job to constraints of that respective worker node and, if the worker node is unable to service a particular job due to constraints of the job or constraints of the worker node, the worker node can reject the job, returning the job to the job queue to be assigned, at a later time, to another worker node that can service the job.

For example, a selected plan for obtaining information related to a hostname can include, but may not be limited to: a job to determine an IP address of a hostname by accessing a third party database; a job to determine an IP address of a hostname by accessing a domain name service; a job to determine one or more header or header types received in response to a request submitted to the hostname; a job to retrieve one or more resources (e.g., style sheets, scripts, images, text, files, and so on) hosted by a server responding to queries submitted to the hostname; a job to enumerate subdomains of the domain name; a job to obtain a Robot Exclusion Standard file; a job to submit a query to a third-party database regarding the hostname or one or more owners or administrators of the hostname; and so on.

As noted with respect to other embodiments described herein, once one or more plans and/or jobs are scheduled to be executed, the computational work associated with such plans and jobs can be assigned to one or more worker nodes in a pool of worker nodes, which are typically ephemeral. An example pool of worker nodes is provided in FIG. 2 and is identified as the pool of worker nodes 210. As noted above, each of the worker nodes 210 can be associated with a constraint schema unique to each worker node.

The constraint schema(s) can be stored by the worker nodes 210 themselves or, in other embodiments, the constraint schema(s) can be stored by one or more of the data stores 206. In either case, as noted above, jobs scheduled by the blackbox analysis system 202 will only be accepted and/or performed by worker node(s) of the pool of worker nodes 210 that can satisfy all the constraints of the particular job.

Further, as noted above, one example constraint required of worker nodes such as described herein is a taint score constraint. More specifically, no worker node will accept a job if the (worst case) taint score associated with that job will cause the worker node to exceed a maximum taint threshold. As a result of this construction, no worker node should become detectable to a conventional security control if, in a particular implementation, taint scores and taint score thresholds are set to appropriate levels.

As computational work is performed and completed across the open Internet 212 by the various worker nodes of the pool of worker nodes 210, the blackbox analysis system 202 continually receives (and/or fetches from one or more worker nodes) information and/or data that may, or may not, be related to the target organization. Thus, as the blackbox analysis system 202 ingests data that results from the completion of work, each data item is tagged and/or categorized based on a confidence that the data item actually relates to the target organization.

For example, a first job to determine an IP address of a hostname by accessing a third party database may return a different IP address than a second job to determine an IP address of a hostname by accessing a domain name service. Accordingly, in this example, a result of the computational work of the first job (e.g., the IP address returned from the third party database) may be categorized as a low-confidence data item whereas the result of the computational work of the second job (e.g., the IP address returned from the domain name service) may be categorized as a high-confidence data item.

Additionally, as the blackbox analysis system 202 ingests data that results from the completion of work, each data item can be analyzed to determine whether that data item is related to, or otherwise associated with, another data item already ingested by the blackbox analysis system 202.

For simplicity, such an operation is referred to herein as building and/or updating a mathematical “graph” of data items, wherein each “point” of the graph corresponds to a particular data item and each “edge” of a graph corresponds to a relationship between connected points. In many examples, a graph—such as described herein—can be a simple graph, a pseudograph, or a multigraph having directed or undirected edges, or oriented or un-oriented edges; it may be appreciated that any suitable graph may be constructed.

In another, non-liming phrasing, as the blackbox analysis system 202 ingests data, one or more existing edges or points (of one or more connected or discrete graphs) can be updated. For example, in response to determining with high confidence that a particular IP address is associated with a hostname, an edge of a graph connecting the IP address data item to the hostname data item can be categorized as a high-confidence connection.

Similarly, if the blackbox analysis system 202 is highly confident that the hostname data item is actually associated with the target organization, a confidence value of the IP address data item can be increased as well. In this manner, new data items ingested by the blackbox analysis system 202 can change previously-determined confidences in other data items and graph edges already ingested or stored by the blackbox analysis system 202. It may be appreciated that confidence values can be adjusted or modified by the blackbox analysis system 202 in any suitable manner; confidences may be increased, decreased, ignored, nullified, and so on.

As noted with respect to other embodiments described herein, as the blackbox analysis system 202 ingests data associated with a particular operation or task (e.g., reconnaissance, resource discovery, service discovery, and so on), additional plans, jobs, or items of work can be automatically scheduled. For example, a resource discovery operation can follow a reconnaissance operation. In another example, a service discovery operation can follow a resource discovery operation, and so on.

For example, as shown in FIG. 2, the blackbox analysis system 202 may discover the computing resource 214 as a result of a resource discovery operation that was scheduled after completion of at least some computational work associated with a reconnaissance operation that, as one example, had discovered a subdomain owned by the target organization.

Continuing the preceding example, after completion of at least some computational work associated with the resource discovery operation, a service discovery operation can be performed against the computing resource 214. As a result of completion of at least some computational work associated with the service discovery operation, a service 216 may be discovered. In addition, as a result of completion of at least some computational work associated with the service discovery operation, the service 216 may be discovered to have a vulnerability 218.

Continuing the preceding example, the blackbox analysis system 202 may also discover the computing resource 220 as a result of the resource discovery operation that was scheduled after completion of at least some computational work associated with the reconnaissance operation referenced above. In this example, after completion of at least some computational work associated with the resource discovery operation, a service discovery operation can be performed against the computing resource 220 that discovers a service 222 with a vulnerability 224. In addition, as a result of the resource discovery operation, the blackbox analysis system 202 may determine that the computing resource 220 is likely to be communicably coupled to a private network 226 controlled by the target organization (e.g., based on a determined physical location of the computing resource 220, based on a database 228 to which the computing resource 220 has access, and so on).

As with other embodiments described herein, the blackbox analysis system 202 may also be configured to perform an appeal scoring operation in which an appeal or temptation score is set or updated for a particular computing resource or service. Similar to confidence scoring, an appeal scoring operation can occur with, or after, other operations described herein.

In one example, the blackbox analysis system 202 may determine that the computing resource 220 has a higher appeal, or a greater temptation value, than the computing resource 214 to an antagonistic third party based on a determination that the computing resource 220 is likely to be communicably coupled to the private network 226.

In another example, the blackbox analysis system 202 may determine that the computing resource 220 has a higher appeal than the computing resource 214 based on a determination that the computing resource 220 is likely to be communicably coupled to the database 228.

In another example, the blackbox analysis system 202 may determine that the computing resource 220 has a higher appeal than the computing resource 214 based on a determination that the vulnerability 224 is more reliably exploited than the vulnerability 218.

In still other embodiments, other means of increasing, decreasing, adjusting, or setting a temptation value or appeal score—whether or not an exploit is known to exist for a particular service or set of services—can be used, including, but not limited to: accessing a database or lookup table based on a service type, service version, service host, and so on; accessing a database or lookup table based on a computing resource type, computing resource version, and so on; accessing a database or lookup table based on an indicator of unsophisticated implementation; and so on.

Once a computing resource or service of a computing resource is determined to be of high appeal to an antagonistic third party and, additionally, is determined to have a vulnerability, the blackbox analysis system 202 can (optionally) signal the client device 208 to request authorization to exploit the vulnerability. In response, the blackbox analysis system 202 can retrieve an appropriate exploit payload (e.g., precompiled binary, plain text script, SQL injection strings, and so on) stored in a database of the data stores 206 in order to exploit the vulnerability.

Thereafter, the blackbox analysis system 202 can package the retrieved exploit payload with a job and assign that job to a worker node in the pool of worker nodes 210. Upon successful exploitation of the vulnerability (e.g., the vulnerability 224), the blackbox analysis system 202 can (optionally) signal the client device 208 to report that a computing resource under the control of the target organization has been successfully compromised and, optionally, that additional computing resources (such as the database 228 shown in FIG. 2) which are or may be communicably coupled to the compromised computing resource may also be vulnerable to an exploit.

These foregoing embodiments depicted in FIGS. 1A-2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

For example, it may be appreciated that—generally and broadly—embodiments of a system described herein can be configured to autonomously conduct or perform blackbox analysis of a target organization by recursively assigning and/or scheduling specific computational work (that may be associated with reconnaissance, resource discovery, service discovery, appeal scoring, resource or service exploitation, mining of compromised computing resources, and perspective pivoting) to one or more worker nodes of a pool of worker nodes that satisfy both job-specific or worker-specific constraints, implemented as virtual machines accommodated by one or more virtual computing environments (hosted or provided by one or more cloud services vendors). In addition, a system such as described herein can leverage modular network topologies to increase scalability, increase information security, and increase reliability.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

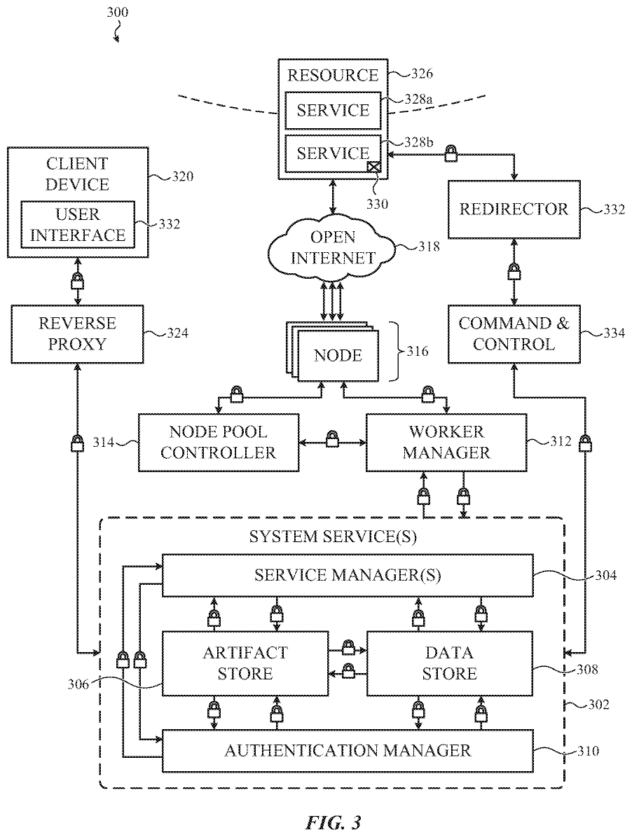

For example, FIG. 3 depicts another schematic representation 300 of a blackbox analysis system 302, such as described herein. The blackbox analysis system 302 can be configured in a similar manner as described above in reference to the embodiment shown in FIG. 2; this description is not repeated.

In the illustrated embodiment, the blackbox analysis system 302 includes a number of service managers (identified, collectively, as the service managers 304), a number of data stores (two of which are identified as the artifact store 306 and the data store 308), and an authentication manager 310.

As with other embodiments described herein, the service managers 304 of the blackbox analysis system 302 can be configured in any suitable manner to determine plans, jobs, and/or work to be performed. The service managers 304 can be configured in a similar manner as described above in reference to the embodiment shown in FIG. 2; this description is not repeated.

As with other embodiments described herein, the data stores of the blackbox analysis system 302 can be configured to securely store (e.g., in an encrypted database) any suitable data. In the illustrated embodiment, the blackbox analysis system 302 includes an artifact store 306 that is specifically configured to securely store files in any arbitrary format of any size. In typical implementations, the artifact store 306 can be used to store, in an encrypted manner, data or other files exfiltrated from a compromised resource.

Additionally, in the illustrated embodiment, the blackbox analysis system 302 includes a data store 308 that is specifically configured to securely store data items obtained or otherwise retrieved in the course of a blackbox analysis of a target organization.

The blackbox analysis system 302 also includes an authentication manager 310. The authentication manager 310 can be purpose-configured to store, retrieve, and verify cryptographic tokens, credentials, keys, certificates, and the like, in order to facilitate secure communication by and between modules or components of the blackbox analysis system 302. In the illustrated embodiment, a lock-shaped icon is used, generally and broadly, to indicate a secure communication channel. In many cases, these secure communication channels—and/or credentials associated with such channels—can be established, at least in part, by the authentication manager 310.

In the illustrated embodiment, the blackbox analysis system 302 is also coupled to a workload manager 312 and a node pool controller 314. In some embodiments, the node pool controller 314 may not be required. The workload manager 312 can be configured to supervise the assignment of computational work and the execution of computational work that is performed by one or more of the worker nodes associated with a pool of worker nodes 316 each configured to perform computational work across the open internet.

For example, the workload manager 312 may be configured to supervise and/or monitor, without limitation: processor utilization of one or more worker nodes; memory utilization of one or more worker nodes; network traffic of one or more worker nodes; processes or operations running on one or more worker nodes; how many worker nodes are in the pool of worker nodes 316; the age of one or more worker nodes; how many nodes are in service; how many nodes should be discarded; and so on.

Further, the workload manager 312 can be configured to assign and/or rate-limit work assigned to the various worker nodes of the pool of worker nodes 316 (e.g., to prevent accidental denial of service effects to a computing resource of a target organization) based on one or more constraint schemas associated with jobs to be assigned and/or particular worker nodes.

For example, the workload manager 312 may be configured to determine an order by which new work is assigned to worker nodes that satisfies constraints of a particular job—including constraints related to taint scores. One example is a round-robin or first-in-first-out order, although other orderings, both random and patterned, are possible.

Further, the workload manager 312 may be configured to listen for completion or failure of jobs or computational work. In this manner, the workload manager 312 can serve as a proxy for communication between the blackbox analysis system 302 and the worker nodes in the pool of worker nodes 316.

In some cases, the workload manager 312 can buffer or queue results of one or more jobs fetched or received from one or more worker nodes prior to announcing to the blackbox analysis system 302 that a job or a plan has completed. In some implementations of these examples, information—including data items or documents—can be communicated between the workload manager 312 and the blackbox analysis system 302 in batches.

The node pool controller 314 is communicably coupled to the workload manager 312 and is configured to manage the provisioning and decommissioning (e.g., setup and cleanup) of worker nodes based on instructions or signals received from the workload manager 312. For example, if the workload manager 312 determines that a worker node should be discarded based on—in one example—a determination that the worker node has not accepted new work for a threshold period of time, the workload manager 312 can signal the node pool controller 314 to initiate the process of decommissioning or otherwise retiring that worker node. In other cases, a worker node can signal the node pool controller 314 indicating to the node pool controller 314 that the worker node is self-retiring.

Similarly, if the workload manager 312 determines that one or more worker nodes are required to service a job or a plan received from the blackbox analysis system 302, the workload manager 312 can signal the node pool controller 314 to initiate the process of provisioning new worker nodes that can satisfy constraints of the work/jobs to be performed.

In some cases, the node pool controller 314 and the workload manager 312 can be implemented as a single controller or manager.

The blackbox analysis system 302, as with other embodiments described herein, can implement a client-server architecture in order to communicate with a client device 320 that includes a user interface 322 for receiving input from, and displaying output to, a representative of a target organization. In some embodiments, the client-server architecture implemented by the blackbox analysis system 302 can be positioned behind a reverse proxy 324 or other traffic-directing network appliance in order to further isolate the blackbox analysis system 302 from the client device 320 or, more generally, the open internet 318.

As noted with reference to other embodiments described herein, the blackbox analysis system 302 can be configured to perform blackbox analysis of a target organization. As with the embodiment(s) described above in reference to FIG. 2, the blackbox analysis system 302 can be configured to perform reconnaissance, resource discovery, service discovery, appeal scoring, resource or service exploitation, mining of compromised computing resources, and/or perspective pivoting.

In the illustrated example, the blackbox analysis system 302 has discovered the presence of a computing resource 326 and two services of that computing resource, one of which is a service not known to have a vulnerability (identified as the secure service 328a) and one of which is a service that is known to have a vulnerability 330 (identified as the insecure service 328b).

As described in reference to other embodiments presented herein, the blackbox analysis system 302 in the illustrated embodiment can autonomously and automatically access an exploit store (e.g., within the data store 308) to retrieve an exploit payload to package with a job assignment to one or more worker nodes to perform the computational work of executing the exploit (e.g., delivering the payload) of the vulnerability 330 of the insecure service 328b of the computing resource 326.

In many embodiments, the exploit payload—and/or the worker node(s) deploying the exploit payload—is configured to perform a self-diagnostic routine or operation to verify whether the exploit of the insecure service 328b was successful. If the exploit was not successful, a message or announcement can be optionally provided back to the blackbox analysis system 302 (e.g., via the workload manager 312, or via a dedicated callback route defined by a redirector 332 and/or a command and control server 334). In other cases, an exploit may fail intentionally silently. In still other cases, a second worker node can be assigned to perform computational work to verify whether an exploit of a service succeeded.

If an exploit payload is successfully delivered, a number of subsequent operations can be performed. For example, in many embodiments, an exploit payload may be configured to attempt privilege escalation. In other embodiments, an exploit payload may be configured to perform a mining operation.

In many embodiments, however, an exploit payload is configured for a limited purpose of establishing a communication channel from the compromised computing resource back to the blackbox analysis system 302 via a dedicated callback route defined by a redirector 332 and/or a command and control server 334. The redirector 332, which may be ephemeral or otherwise, is configured to obfuscate the destination of communications originating from a compromised computing resource, such as the computing resource 326 as shown in FIG. 3. In some embodiments, a redirector 332 may not be required or preferred.

Once an exploit payload establishes communication with either the command and control server 334 or the blackbox analysis system 302, a private communication binary (herein, a “communication payload”)—such as a virtual private network client—can be transmitted and/or otherwise transferred to the compromised computing resource such that communication with the compromised computing resource can be maintained. Once the communication payload is successfully deployed to the compromised computing resource, the blackbox analysis system 302 can utilize the compromised computing resource to perform computational work related to the blackbox analysis. In addition, the blackbox analysis system 302 can utilize the compromised computing resource to mine itself for data, documents, or information for exfiltration to the artifact store 306. In many cases, the compromised computing resource can be configured to encrypt data, documents, or information prior to transmitting the same via the communication channel established by the communication payload, but this may not be required of all embodiments.

Still further, as noted above, a compromised computing resource may have a different “perspective” (which, in turn, can be considered a different constraint) than the public perspective of the worker nodes of the pool of worker nodes 316. In other words, the compromised computing resource may be communicably coupled to—or may have the ability to communicably couple to—one or more resources within a private network controlled by the target organization. As such, the compromised computing resource can be used by blackbox analysis system 302 to perform additional reconnaissance, resource discovery, service discovery, appeal scoring, resource or service exploitation, mining of compromised computing resource, and/or perspective pivoting, such as described herein.

These foregoing embodiments depicted in FIG. 3 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

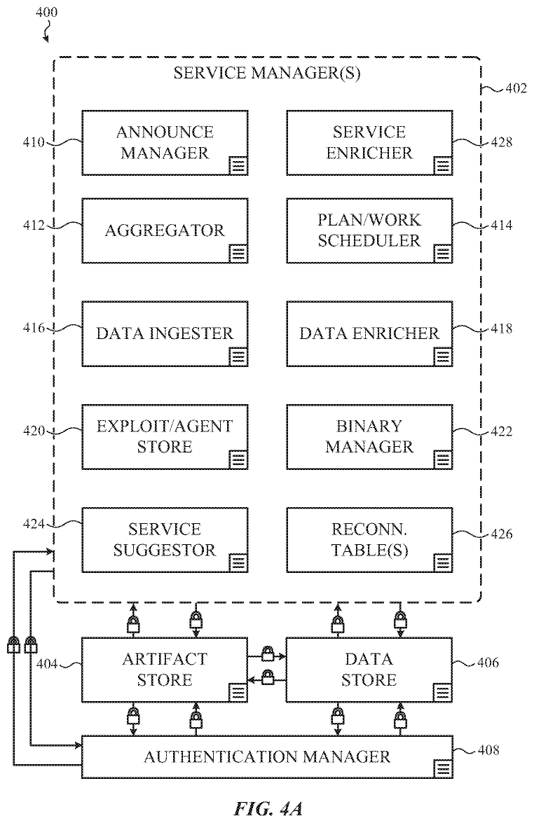

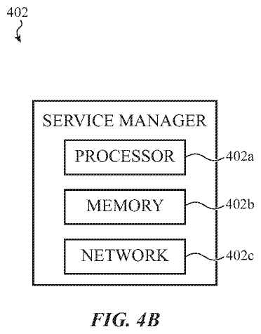

For example, a modularized system, such as described herein, can include a number of purpose-configured physical and/or virtual machines, referred to herein as service managers, each tasked with a particular function or set of functions. FIG. 4A depicts a schematic representation 400 of a blackbox analysis system 402, including a number of discrete service managers.

The blackbox analysis system 402, as with embodiments described in reference to FIG. 3, can be securely communicably coupled to an artifact store 404, a data store 406, and an authentication manager 408. The artifact store 404, the data store 406, and the authentication manager 408 can be configured in the same manner as described above with reference to FIG. 3; this description is not repeated.

As noted above, the blackbox analysis system 402 includes a number of discrete modules or service managers; in the illustrated example, eight discrete modules are shown. In particular, the blackbox analysis system 402 includes an announcement manager 410, a data aggregator 412, a plan scheduler 414, a data ingester 416, a data enricher 418, an exploit/agent store 420, a binary manager 422, a service suggestor 424, a reconnaissance table generator/store 426, and a service enricher 428.

It may be appreciated that although communication paths are not shown to couple each of the service managers of the blackbox analysis system 402 depicted in FIG. 4A, secure communication channels are understood to couple each service manager to each other service manager or, alternatively, to couple specific service managers to one another; any suitable signal path or communication pathways may exist or be established. It is appreciated that these paths are omitted from FIG. 4A for simplicity of illustration.

In this architecture, the announcement manager 410 of the blackbox analysis system 402 is configured to coordinate communications between two or more of the various service managers of the blackbox analysis system 402. For example, the announcement manager 410 can be configured to subscribe to, or otherwise listen for, announcements from one or more worker nodes of a pool of worker nodes and/or one or more of the various service managers of the blackbox analysis system 402. In one example, the announcement manager 410 is configured to host, operate, or otherwise participate in a message queue or message subscription service, such as RabbitMQ. It may be appreciated, however, that this is merely one example and that other communication(s) protocols may be suitable.

In some embodiments, the data aggregator 412 of the blackbox analysis system 402 is configured to monitor and supervise the state of all data in the blackbox analysis system 402. In this manner, the data aggregator 412 can serve as a change-tracking and/or version tracking system that facilitates capture of data or information and facilitates capture of how data or information obtained by the blackbox analysis system 402 changes over time. For example, the data aggregator 412 can be configured to monitor and record how IP addresses associated with a particular computing resource or hostname change or are assigned over time, how subdomains of a domain change over time, how ports or other communication channels of a computing resource open or close over time, and so on.

In addition, the data aggregator 412 of the blackbox analysis system 402 can be configured to regularly (e.g., at regular intervals or in response to a time-based or event-based trigger) comb through one or more databases, such as the data store 406 and/or the artifact store 404, in order to implement strict change tracking for all fields of all data items and documents stored in those databases. In this manner, the data aggregator 412 of the blackbox analysis system 402 memorializes effectively every change, movement, or modification of data that occurs in the course of operating the blackbox analysis system 402. As a result, every action performed by the blackbox analysis system 402, and/or any module or service thereof, can be audited at a later time.

For example, as a result of the data aggregator 412, the blackbox analysis system 402 can track, for each data item: the work performed to obtain the data item; identity and/or addresses of the worker node(s) that performed the work to obtain the data item; the time, manner, or format in which the data item was received by a workload manager; the time(s) or manner(s) by which the data item was formatted or modified by the blackbox analysis system 402; the time(s) at which the data item was accessed by a user of the blackbox analysis system 402; the identity of a user of the blackbox analysis system 402; and so on. It may be appreciated that the foregoing list is not exhaustive.

In some embodiments, the plan scheduler 414 of the blackbox analysis system 402 is configured to determine a plan and/or a series of jobs or computational work to be performed to accomplish an objective or task of the blackbox analysis system 402. In some examples, these operations may include selecting worker nodes to perform work based on one or more constraints or constraint schemas associated with those worker nodes and/or jobs to be performed.

In some examples, the plan scheduler 414 can be configured to announce to other modules or service managers of the blackbox analysis system 402 when work is assigned and/or completed. In addition, the plan scheduler 414 can determine one or more dependencies of a plan, a job, or an item of computational work.

For example, in some cases, a job may require particular information, particular permissions, or may require a worker node to have a particular perspective (or other constraint, such as a low taint score) before being able to be assigned. In these circumstances, the plan scheduler 414 of the blackbox analysis system 402 can be configured to access the artifact store 404 and/or the data store 406—and/or any other suitable local or remote database—in order to fulfill a dependency of a particular job or a particular plan. In typical embodiments, the plan scheduler 414 is configured to directly communicate with a workload manager (or via the announcement manager 410), such as the workload manager 312 depicted and described in FIG. 3.

In some embodiments, the data ingester 416 of the blackbox analysis system 402 is configured to receive and/or fetch the results of completed work. In many embodiments, the data ingester 416 can be configured to include one or more data analysis pipelines that receive raw data or information at an input end and provide an output at an output end. The data ingester 416 may be configured to process stream data and/or file data.

The pipeline(s) of the data ingester 416 may include a number of purpose-configured modules, microservices, or lambda functions that are each tasked with detecting or extracting a specific feature from a specific input. For example, one data detector may be configured to extract IP addresses from text whereas another data detector may be configured to extract MAC addresses from text. In further examples, a higher level of abstraction may be useful. For example, a data detector may be configured to detect a service. For example, a given data detector may be configured to detect “Windows Vista Server” and may be configured to provide an output only once a sufficient quantity of property-signaling data (e.g., open port list, content of admin panel HTML, version number, software name, and so on) has been received. As may be appreciated, the receipt of data from one or more worker nodes may be received asynchronously and may be processed by the data ingester 416 in an event-driven manner. In a more simple phrasing, it may be appreciated that, in certain configurations, a data detector may be configured to aggregate raw data as it is received (typically on a per-organization and per-computing resource basis) and may be configured to provide an output only after a sufficient quantity or type of data is received to make a positive or statistically relevant identification of a given property or a specific service. For example, a data detector may receive a result of work indicating “windows” and, at a later time, may receive a result of work indicating “XP Service Pack 2.” Only after the second work is received may this example data detector output an indication that “Windows XP Service Pack 2” as a service has been detected.

Communication between the data ingester 416 and other components or services of the blackbox analysis system 402 can be facilitated and/or controlled in whole or in part by the announcement manager 410, although this is not required. In some cases, the data ingester 416 may be communicably coupled to the plan scheduler 414 via a secure communication channel established, at least in part, by the authentication manager 408.

In these examples, the plan scheduler 414 may fetch results of computational work from a workload manager (and/or a worker node directly) and, in response, may announce to the data ingester 416 that raw data is ready to be fetched by the data ingester 416 for processing. In other embodiments, the data ingester 416 may directly interface with a workload manager or a worker node in order to obtain raw data and/or other results of completed work.

The data ingester 416 can be configured to parse and/or otherwise process and/or parse data in any suitable manner. For example, in many embodiments the data ingester 416 is configured to parse and/or process data according to a job or plan type associated with the job that resulted in the data. In other cases, the data ingester 416 is configured to leverage a trained or untrained artificial intelligence algorithm or matching algorithm to detect particular data types and/or particular data items. For example, in one embodiment, the data ingester 416 includes one or more databases of Regular Expressions.

In still other embodiments, the data ingester 416 can include, or can be supported by, one or more image or text processing algorithms or modules. For example, in some embodiments, documents or images may be exfiltrated from a target organization. In these examples, the data ingester 416 can include an optical character recognition algorithm and/or an image recognition algorithm to extract text and/or image-based contextual information.

For example, in one specific embodiment, the data ingester 416 may receive a rasterized image or document exfiltrated from a compromised computing resource. The data ingester 416 can leverage an optical character recognition algorithm to determine whether readable text appears in the rasterized image or document. In addition or alternatively, the data ingester 416 can leverage an image processing algorithm, a computer vision algorithm, an object recognition algorithm, and/or a facial recognition algorithm to determine the content of the rasterized image or document. In still further embodiments, additional supplemental processing steps or preprocessing steps may be used.

In many embodiments, the data ingester 416 is directly communicably coupled (e.g., via a secure communication channel established, at least in part, by the authentication manager 408) to one or more databases, such as the artifact store 404 and/or the data store 406. As a result of this network topology, the data ingester 416 can be configured and positioned to add data items into one or more databases substantially immediately after those data items are parsed or otherwise extracted from raw information or data received by the data ingester 416.

In some embodiments, the data enricher 418 of the blackbox analysis system 402 can be configured to comb through one or more databases of existing data, such as the artifact store 404 and/or the data store 406, in order to improve the quality and/or usefulness of the data contained therein. In this manner, the data enricher 418 of the blackbox analysis system 402 acts on data already stored in a database.

For example, the data enricher 418 of the blackbox analysis system 402 can be configured to provide or calculate one or more mathematical properties of a data item or a set of data items contained in a database such as, but not limited to: average value; maximum value; minimum value; deviation from expected value; and so on. In other cases, the data enricher 418 can be configured to perform one or more appeal scoring operations and/or confidence scoring operations on data contained in a database. For example, the data enricher 418 of the blackbox analysis system 402 can be configured to periodically comb through a database to determine whether a confidence value or an appeal value should be updated based on data that has been added to the database recently.

To advance this objective, the data enricher 418 of the blackbox analysis system 402 may be tasked in certain embodiments with updating and/or creating one or more graph representations of the data stored in a database, such as the data store 406 or the artifact store 404. In other words, the data enricher 418 of the blackbox analysis system 402 can be configured to analyze the connections (e.g., depth) between individual linked data items, can be configured to monitor for data item clustering, and so on.

In still further examples, the data enricher 418 of the blackbox analysis system 402 can be configured to access a third-party database to add context or supplemental data or metadata to a particular data item. For example, an IP address may be a data item. In this example, the data enricher 418 of the blackbox analysis system 402 may be configured to access a geolocation database to assign an approximate geographic location to a particular IP address.

In some embodiments, the exploit/agent store 420 of the blackbox analysis system 402 can be configured, as a database or other storage structure or apparatus, to store the code and/or binary executables required to execute exploits of vulnerable services that may be detected by the blackbox analysis system 402. For example, it may include a database of available and/or known exploits, categorized and/or tagged based on a service, service type, service version, and so on. In this manner, if the data ingester 416 receives data corresponding to a discovery of a service, the data enricher 418 may access, via a secure channel established at least in part by the authentication manager 408, the database of the exploit/agent store 420 to determine whether the discovered service is exploitable.

In other cases, the exploit/agent store 420 includes a database of known exploits and a database of implemented exploits. In this example, the exploit/agent store 420 can be used to determine whether a service is vulnerable to an exploit that is known to the public, but that is not yet implemented by, or able to be performed by, the blackbox analysis system 402.

In some embodiments the exploit/agent store 420 may also be used to store communication payloads, such as described above.

In some embodiments, the binary manager 422 of the blackbox analysis system 402 may be communicably coupled, via a secure channel established at least in part by the authentication manager 408, to the exploit/agent store 420. The binary manager 422 may be configured to compile and/or retrieve from the exploit/agent store 420, on demand, a suitable binary to deploy to a particular operating system or to a particular computing resource. In further embodiments, the binary manager 422 may be configured to selectively, or in response to a signal or instruction from another module or service manager of the blackbox analysis system 402, recompile an already-compiled binary in order to change the hash of the binary to avoid detection.

In some embodiments, the service suggestor 424 of the blackbox analysis system 402 may be configured to monitor for services for which no known exploit exists and/or no exploit is implemented or otherwise available to the blackbox analysis system 402. In other cases, the service suggestor 424 of the blackbox analysis system 402 may be configured to monitor outputs of services for which no known use or leverage can be achieved.

For example, a work or job performed by a worker node (that was initially planned and/or assigned by the plan scheduler 414), can probe an IP address believed to be associated with a target organization and may determine that the remote computing resource is executing a server software referred to as NewServer 0.1. This data may be unknown to any of the services (e.g., and, thus, may not be enriched to any significant extent by the data enricher 418 after being ingested by the data ingester 416), but will still nevertheless be stored by the system. In this manner, over time, the service suggestor 424 may be configurable to recognize patterns developing with respect to discrete data items collected by the blackbox analysis system 402. More simply, once the service suggestor 424 recognizes that NewServer 0.1 is apparently used by at least a threshold number of target organizations or, additionally or alternatively, is used by - or otherwise appears to be executed by—a number of discrete remote computing resources, then the service suggestor 424 may cause a notification to be generated to a data analyst (e.g., native application notification, web notification, email notification, user interface adjustment, user interface overlay, and so on) that suggests that the data analyst invest resources in analyzing NewServer 0.1 to determine whether that system can be leveraged in any meaningful way to provide information and/or to be exploited to execute arbitrary computer code.

The various thresholds that may be referenced by a service suggestor 424, such as described herein can be any suitable thresholds, and may vary from embodiment to embodiment. In one example, the threshold that, once satisfies, triggers the blackbox analysis system 402 and, more specifically, the service suggestor 424 to generate a notification to a data analyst may be a small number, such as two occurrences.

In other cases, the threshold may vary based on the size of an organization or the type of industry and type of new service being suggested. For example, a new service recognized for a network communications appliance manufacturer may be of higher priority (and thus associated with a lower threshold) than a new service recognized for a headquarters of a services business.

In other cases, a type of the new service may be used as an important factor to determine when to notify a data analyst. For example, a new version of an existing web service (e.g., WordPress 9.0) may be a high research priority due to a presumption that end users will upgrade.

In still further examples, a new type of hardware and/or software that is known to a data analyst as being difficult to exploit or otherwise leverage may be prioritized lower, at least due to the increased research and development effort that the data analyst predicts would be required to use the new hardware or software service.

In this manner, in view of the foregoing, it may be appreciated that the embodiments described herein referencing temptation scoring of specific computing resources can be equivalently applied to services of unknown value previously discovered by the blackbox analysis system 402. In this manner, it may be appreciated that a similar configuration can be used to recommend services to a data analyst. For convenient and consistent reference, such a configuration of a blackbox analysis system such as described herein is referred to as “service temptation scoring.”

As with computing resource temptation scoring, service temptation scoring may attempt to leverage information about a computing resource, a target organization, or any other information to effectively mimic the behavior of an adversarial third party with respect to research and development effort. To that end, the service suggestor 424 may be configured to perform a heuristic analysis of one or more discovered services of unknown value in order to tag, categorize, organize, score, value, grade, sort, and/or prioritize those discovered services based on a predicted appeal of each service to the attention of an antagonistic third party.

The predicted appeal of a discovered service of unknown value may be based on, without limitation: an industry of a target organization; the number of times the service of unknown value has been detected with respect to a particular organization, a particular industry, a particular security control vendor, a particular geographic location, and so on; the number of times the service of unknown value has been detected alongside another service or set of services; the quantity of data known about and/or received from the service of unknown value; a service type (e.g., web server, security appliance, industrial control device, automation control device, peripheral device, and so on); a service sophistication (e.g., number of features or functions provided or predicted to be provided, complexity of function provided); a predicted security prioritization the maker of the service would have paid when finalizing the service (e.g., network infrastructure manufacturers may be predicted to be more security conscious than Internet-Of-Things manufacturers); a communication path or traceroute to the service; an ease of coupling to the service from a public perspective (e.g., via the open Internet); a likelihood that the service is communicably coupled to another service of interest (e.g., a security camera is likely coupled to security infrastructure via a security VLAN); and so on.

For example, if the system determines that a target organization has a number of services of unknown value (e.g., identified by IP addresses within the same block as a web page, for example) that all report a software service of “CameraCompany Wi-Fi Model 0.11.222.” it may be the case that no other organization utilizes such cameras. In this example, the service suggestor 424 may determine that the service is a high priority at least due to the fact that the unknown service is likely communicably coupled to security infrastructure, which may include security camera access, physical building access, network video controller/recorder access, and so on. Further, the service suggestor 424 may prioritize notifying the data analyst at least due to the fact that the cameras were discovered across an unencrypted TCP connection, such as HTTP. More specifically, the system may predict that if a security camera is coupled to a network via unencrypted Wi-Fi, it is likely that the security attention paid by the original equipment manufacturer (“OEM”) is low, and, thus, an exploit may be possible. In still further examples, the service suggestor 424 may be configured to operate with a service enricher (see, e.g., the service enricher 428 described below) that, in turn, is configured to obtain supplemental information about the service of unknown value. As a simple example, the service enricher may attempt to perform one or more internet searches to determine, without limitation: a price bracket of the product when purchased on the open market; an indication of whether an exploit exists; a quantity of forum discussion regarding security of the service; a location of the OEM (e.g., certain countries may be associated with lower security care than others); and so on.

Continuing the example introduced above, the service suggestor 424 may be further configured to compare a predicted security sophistication of the target organization and/or a predicted security budget range of the target organization when determining whether to recommend to the data analyst whether to invest time and resources into researching the discovered service of unknown value. For example, the system may be configured to notify a data analyst with information such as: “Company XYZ has 10×Wi-Fi security cameras each serving an admin console accessible from a public perspective via HTTP that appear to be manufactured in, and sold from, China, from the OEM MegaCorp. MegaCorp produces a number of products using Arch Linux 0.1. This device is available via BudgetBusinessGadgetz.info for $19.99. Several GitHub projects exist that reference this camera model.” With this information, the data analyst may determine whether to invest research and development effort based on the perceived ease of developing an exploit or finding an existing exploit. In particular, in this example, the data analyst and/or the service suggestor 424 may bias the relative importance of developing an exploit for the cameras based, at least in part, on a high temptation score. In other words, the service suggestor 424 may determine that low-security security cameras may be highly tempting to a motivated threat actor despite that the cameras themselves may present a small likelihood of containing useful information that may be exfiltrated from the organization.

For example, if the system determines when pivoting from an internal perspective that a target organization has a number of services of unknown value that all report a software service of “NetworkSwitch,” as with the previous example, it may be the case that no other organization utilizes such network switches. In this example, the service suggestor 424 may determine that the service is a low priority at least due to the fact that the unknown service can directly facilitate communication with other networked devices from the internal perspective. In other cases, however, the service suggestor 424 may determine that the service is a high priority at least due to the fact that an exploit of a network switch may enable a perspective pivot across VLANs of the organization. In other words, the service suggestor 424 may determine that moderate security network switches may be highly tempting to a motivated threat actor despite that the switches themselves may present a small likelihood of containing useful information that may be exfiltrated from the organization.

A person of skill in the art may appreciate that different circumstances may warrant different prioritizations; the foregoing examples are not exhaustive.

Once such a service is detected by the service suggestor 424, the service suggestor 424 can generate a message (e.g., directed to an administrator of the blackbox analysis system 402, or to another data analyst or specified individual or group of individuals) that suggests development attention to the service. In some cases, the system may be configured to automatically create a trouble ticket or an issue in an issue tracking system used by a software development team maintaining the system described herein.

The forgoing examples are not exhaustive; it may be appreciated by a person of skill in the art that a service suggestor, such as the service suggestor 424, may operate in a number of suitable ways, according to organization-specific paradigms, and/or according to manually configured decision trees or equivalents to perform, coordinate, or monitor one or more operations to evaluate and/or predict a temptation of a given service to a given antagonistic actor and/or that antagonistic actor's skill set or motivation. In other words, the service suggestor 424 may operate to suggest services differently if mimicking the behavior of an unsophisticated vandal than if mimicking the behavior of a motivated cyber-criminal likely to extort a target organization.

In some embodiments, the reconnaissance table generator/store 426 of the blackbox analysis system 402 can be communicably coupled via a secure channel established at least in part by the authentication manager 408, to one or more databases of the blackbox analysis system 402, such as the data store 406 or the artifact store 404. The reconnaissance table generator/store 426 can be configured to display data queried from these databases in a readable and operator-consumable format. The form and function of these tables may vary from embodiment to embodiment, and it may be appreciated by a person of skill in the art that different implementations may prefer different organizations and/or displays of data.

In some embodiments, the service enricher 428 of the blackbox analysis system 402 can be configured to comb through one or more databases of existing data, such as the artifact store 404 and/or the data store 406 and/or the reconnaissance tables 426, in order to improve the quality and/or usefulness of the data contained therein and/or decisions of the system made therewith. In this manner, in many embodiments, the service enricher 428 of the blackbox analysis system 402 acts on data already stored in a database. In a more simple phrasing, the service enricher 428 of the blackbox analysis system 402 may be configured to operate in a similar manner to the data enricher 418, distinguished in that the data enricher 418 is configured to supplement data retrieved as a result of one or more works performed by one or more worker nodes and, thereafter, stored in a database, such as the artifact store 404, the data store 406, and/or the reconnaissance tables 426 and the service enricher 428 is configured to supplement information used to identify one or more services.

For example, as with the data enricher 418, the service enricher 428 of the blackbox analysis system 402 can be configured to provide or calculate one or more mathematical properties of a service data item or a set of service data items contained in a database such as, but not limited to: average value; maximum value; minimum value; deviation from expected value; and so on. As one example, the service enricher 428 may be configured to determine whether a particular data detector associated with and configured to detect a particular service in order to identify a particular target computing resource is operating efficiently or, alternatively, may be in need of optimization. In this example, the service enricher 428 may be configured to monitor an execution time of a module or other data detector configured to consume data output from a job or work and to output a computer-readable indication or statistical prediction that the input data signals a particular service, such as described above.

In other cases, the service enricher 428 can be configured to perform one or more appeal scoring operations and/or confidence scoring operations on data contained in a database and, in particular, a service data database (not shown). For example, the service enricher 428 of the blackbox analysis system 402 can be configured to periodically comb through a database to determine whether a confidence value or an appeal value should be updated based on data that has been added to the database recently. In other cases, the service enricher 428 can be configured to determine a last successful detection time of each individual data detector. With this data, the service enricher 428 can provide a recommendation to retire one or more data detectors that do not appear to be in use. In other cases, the service enricher 428 can be configured to lower the priority of such a data detector such that new input data is input to the data detectors associated with the most commonly-detected services first. As one specific example, the service enricher 428 may determine that a data detector configured to detect “Windows CE” has not successfully detected a service for a threshold period of time. In this example, the service enricher 428 can lower the priority of this data detector such that a data detector configured to detect “Windows 10” is executed before the data detector configured to detect “Windows CE.” In a further example, the service enricher 428 may be configured to entirely disable the data detector configured to detect “Windows CE.” Additionally or alternatively, the system may be configured to notify an operator and/or a data analyst that “Windows CE” has not been detected for a threshold period of time. The system may provide such a notification in order to highlight to the operator that an error may have occurred with the “Windows CE” data detector and/or the property-identifying data extracted by said data detector has changed and is in need of updating.

To advance these and other objectives, the service enricher 428 of the blackbox analysis system 402 may be tasked in certain embodiments with updating and/or creating one or more graph representations of the data stored in a database that corresponds to different services and data detectors associated therewith. In other words, the service enricher 428 of the blackbox analysis system 402 can be configured to analyze the connections (e.g., depth) between individual linked data items, can be configured to monitor for data item clustering, and so on. In response to determining or inferring relationships between different data detectors (e.g., a first service often occurs with or is often coupled to a second service) exist, the service enricher 428 can suggest one or more new operations, functions, or services of the blackbox analysis system 402. For example, in one configuration a first data detector is configured to detect Service 1 and a second data detector is configured to detect Service 2. After a threshold period of time, the service enricher 428 may determine a threshold number of edges exist in a graph created by the service enricher 428 linking Service 1 to Service 2. Once this relationship is recognized, the service enricher 428 can automatically cause the blackbox analysis system 402 to probe for Service 2 once Service 1 is detected, and vice versa. In other examples, the service enricher 428 may determine that Service 1 and Service 2 are always coexistent. In these examples, the service enricher 428 can cause the blackbox analysis system 402 to automatically presume that Service 2 exists when Service 1 is discovered, and vice versa.

It may be appreciated that the foregoing examples are not exhaustive; in other cases, the service enricher 428 can infer prioritization of execution of various data detectors, can determine one or more relationships between different services, and/or perform various actions (including notifying an operator and/or performing an automatic operation) in response thereto.

In still further examples, the service enricher 428 of the blackbox analysis system 402 can be configured to access a third-party database to add context or supplemental data or metadata to a particular data item or data detector associated with a particular service.

These foregoing embodiments depicted in FIG. 4A and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

For example, it may be understood that the various systems, components, modules, and managers described in reference to FIG. 4A can be physically or virtually implemented in a number of suitable ways. For example, FIG. 4B depicts a simplified block diagram depicting example components of a physical and/or virtual machine that can be configured to operate as any suitable service manager or data store, such as described herein. FIG. 4A depicts, in several locations, a symbol including three horizontal lines disposed in a square; the symbol is intended, for simplicity of illustration, to convey that the simplified example construction depicted in FIG. 4B may be suitable in certain embodiments to implement or otherwise construct any of the functional modules, blocks, or other components of the system depicted in FIG. 4A.

Returning to FIG. 4B, the example service manager 402 includes a processor 402a, a memory 402b, and a communication component 402c, each of which may be interconnected and/or communicably or conductively coupled in any suitable manner. As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory, such as the memory 402b. This term is meant to encompass a single processor or processing unit, multiple processors, multiple processing units, analog or digital circuits, or other suitably configured computing element or combination of elements.

The communication component 402c of the example service manager 402 may be a virtual (e.g., application programming interface) or a physical communication interface (e.g., ethernet, Wi-Fi, Bluetooth, and so on).

In view of the foregoing, it may be understood that these descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

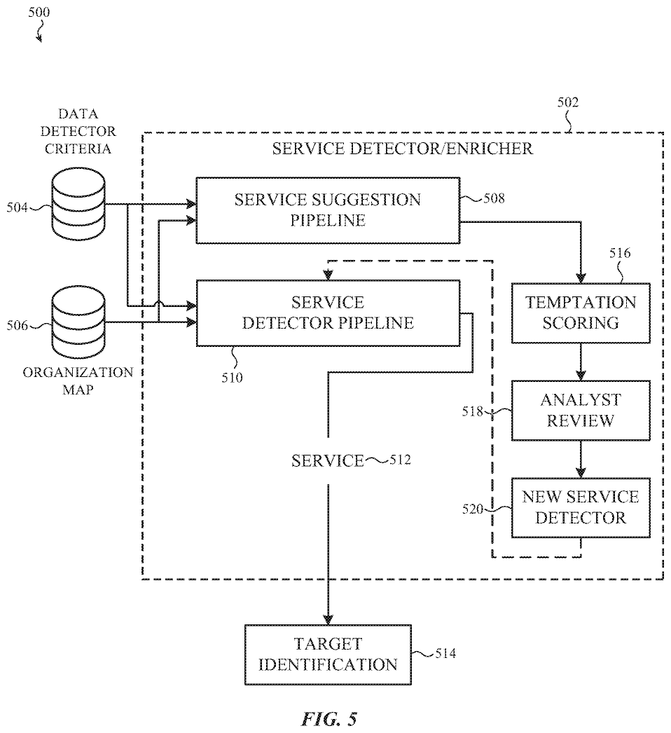

FIG. 5 depicts a schematic representation of a service detector/enricher, such as described herein. The system 500 may correspond, generally, to a service of the blackbox analysis system 402 depicted in FIG. 4A. In particular, the system 500 may correspond generally and broadly to the data ingester 416, the service suggestor 424, and/or the service enricher 428.

In this example embodiment, the system 500 is configured to consume data obtained as a result of one or more works performed by one or more ephemeral nodes. The data consumed by the system 500 may be stream data, file data, or other data. The system 500, as noted above with respect to other embodiments described herein is configured to output an identification of a service based on the input data.

In particular, the system 500 includes a service detector/enricher 502. The service detector/enricher 502 is configured to receive input data from one or more databases, such as a content database 504 (identified in the figure as the data detector criteria database) and/or an organization data database 506 (identified in the figure as the organization map). The content database 504 is configured to store and/or otherwise serve data or information obtained as a result of execution of one or more ephemeral work nodes. The organization data database 506 is configured to store information relevant to a particular target organization and/or a particular target computing device.

The output(s) of the content database 504 and the organization data database 506 can be provided as input to one or more data analysis pipelines of the service detector/enricher 502. In the illustrated embodiment, two discrete data analysis pipelines are shown, each configured for a separate and discrete purpose.

In particular, a first data analysis pipeline—identified as the service suggestion pipeline 508—can be configured to operate in much the same manner as the service suggestor 424 described in reference to FIG. 4A. In particular, the service suggestion pipeline 508 can include a number of discrete data detectors configured to extract information from the data output from the content database 504 and/or the organization data database 506 and to store that data in a database (described below).

The system 500 further includes a second data analysis pipeline—identified as the service detector pipeline 510—that can be configured to operate in much the same manner as the data ingester 416 described in reference to FIG. 4A. In particular, the service detector pipeline 510, as with the service suggestion pipeline 508 can include a number of discrete data detectors configured to extract information from the data output from the content database 504 and/or the organization data database 506 and to store that data in a database and/or otherwise output data to another component of a blackbox analysis system, such as described herein. For example, in many embodiments, the service detector pipeline 510 may be configured to output a computer-readable indication identifying a particular service (e.g., XML, JSON, or any other suitable format, whether object-based, key-value based, or formatted in another manner), such as the service 512. Thereafter, the service 512 may be provided as output to another service or module of a blackbox analysis system, such as a target identification block 514 that receives the service 512 and instantiates an object representation of the service 512 such that the blackbox analysis system can identify and collect information relative to the specific computing hardware/software identified by the system 500. As noted above, the target identification block 514 may be configured to generate an object that represents an instantiated service, such as described above (i.e., a specific instance of a specifically-identified service).

As noted above, the service detector/enricher 502 may be architected according to event-driven design principles. More specifically, as a result of this architecture, the pipeline(s) may only output data once data to output exists. For example, if the service detector pipeline 510 does not include a data detector that positively identifies any service based on input received from the content database 504 and/or the organization data database 506, then no output may be provided by the service detector pipeline 510.

In some cases, output from the service suggestion pipeline 508 may be gated by output provided by the service detector pipeline 510. For example, in some configurations, the two pipelines' output are mutually exclusive. More specifically, output from the service suggestion pipeline 508 may be suppressed if the service detector pipeline 510 provides an output identifying at least one service corresponding to the data input to the service detector/enricher 502.

In other cases, output from the service suggestion pipeline 508 may not be suppressed in response to output from the service detector pipeline 510; in these embodiments, the two pipelines may operate independently, asynchronously, and in parallel.

Whether output(s) provided from the service suggestion pipeline 508 are affected or otherwise influenced by the service detector pipeline 510, once an output is provided from the service suggestion pipeline 508 it may be received by a temptation scoring block 516. In these examples, as described above, the output from the service suggestion pipeline 508 may be analyzed to determine whether the new services suggested by the output(s) of the service suggestion pipeline 508 (or any other data outside a suggestion of a new service to investigate) are tempting to an antagonistic third party or threat actor having a given skill set. As described above, temptation scoring performed by the temptation scoring block 516 may operate similarly to target temptation scoring described above. In this example, the temptation scoring block 516 may increase or decrease a temptation score based on any suitable property of the target organization (obtained from the organization data database 506) or the data itself obtained from the content database 504. As noted above, different services of unknown value may have different temptation scores based on the skill level of the threat actor sought to be mimicked. For example, a low sophistication actor may find security cameras more tempting whereas a high sophistication actor may find Internet-of-Things devices more tempting.

Output from the temptation scoring block 516 may determine whether a human data analyst is notified or otherwise informed of one or more services of unknown value. As noted above, in many embodiments, only those services of unknown value (or other output(s) of the service suggestion pipeline) that have a temptation score as determined by the temptation scoring block 516 that satisfy a threshold may be forwarded to a data analyst for review (e.g., at block 518).

Once a data analyst receives an input from the service suggestion pipeline 508 that exhibits a temptation score that satisfies a selected threshold (e.g., at block 518), the data analyst may draft or design a new data detect at block 520 which, in turn, can be inserted or otherwise added to the service detector pipeline 510.

In some cases, the service suggestion pipeline 508 and/or another element of the service detector/enricher 502 may be configured to provide to the data analyst a template data detector service with partially populated content based on one or more outputs of the service suggestion pipeline 508.

It may be appreciated that the foregoing examples are not exhaustive of the various configurations of a data analysis pipeline leveraged by a service detector, enricher, or suggestor such as described herein. As such, generally and broadly, the pipelines of the service detector/enricher 502 may be configured to operate in any suitable manner, but in many embodiments, each include a set of independently-configured data detectors each configured to detect a discrete service or a property of a data input that may, in some examples, be useful to identify a service.

For example, in many embodiments, a service detector service as described herein may be configured as an instance of software executing over shared or dedicated resource allocations, such as processor allocations and/or memory allocations. The service detector service may execute over virtual resource or physical resource and/or may be instantiated in one geographic location. In other cases, the service detector service may have portions executed/instantiated in different geographic locations.

In such examples, the service detector service can be instantiated as described in reference to other software instances described herein. In particular, the processor allocation can be configured to access an executable asset from the memory allocation to instantiate the service detector service. Thereafter, the service can be configured to select computational tasks, such as reconnaissance tasks, to be performed against one or more target computing resources and/or against one or more remote addresses, such as URLs or MAC addresses that may be associated with one or more computing resources. Upon successful execution of a reconnaissance task (or more generally, a “computational task”) by a worker node, an output of that task can be provided as input to the service detector service. More specifically, the service detector service can include one or more service detectors each configured to determine a statistical confidence that the target of the computational task is configured in a particular manner (e.g., is executing an instance of software having a particular version or configuration or other feature). The statistical confidence can be compared against a threshold to determine whether the service detector service can conclude that the target computing resource actually is configured as predicted by one or more service detectors.

In some embodiments, the service detector service is configured to receive from each of its associated service detectors a data object. The data object can include an identification of a particular software configuration, which as noted with respect to other embodiments described herein can include a software name, a vendor, a version number, and so on. The data object can also include a statistical confidence associated with a likelihood that the software configuration is actually a correct estimation of the current configuration of the target computing device or resource. For example, a reconnaissance operation may query a remote address with a malformed URL to determine how a remote computing resource serving content from that address responds to a malformed URL. Based on a page or other response (e.g., HTTP code) returned from the remote computing resource, a service detector configured to detect an Apache server may generate a data object with a different statistical confidence than a service detector configured to detect a nginx server. More particularly, different Apache configurations and different nginx configurations may each be associated with different service detectors which, in turn, can generate different data objects corresponding to different confidences that the remote resource is a particularly-configured Apache instance or a particularly-configured nginx instance. Thereafter, high-confidence data objects (e.g., determined by comparing statistical confidences to a threshold) may be used to inform selection of further reconnaissance operations.

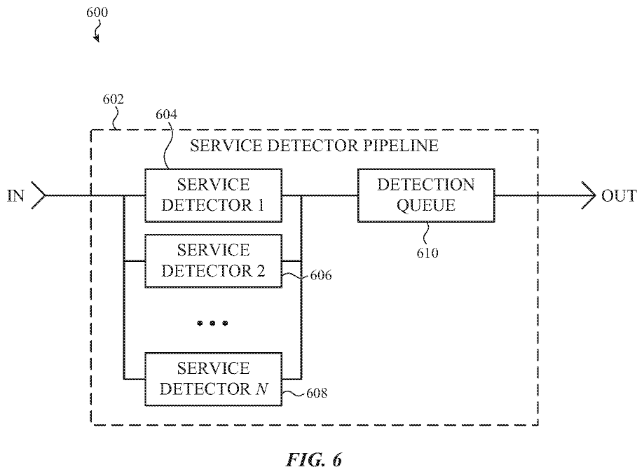

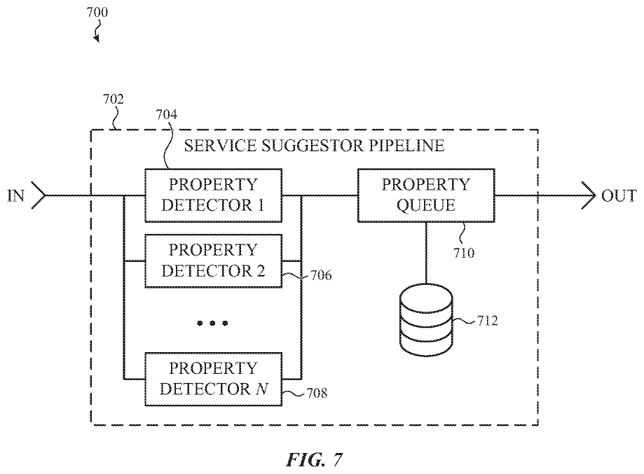

Example configurations of data analysis pipelines such as described herein are described in reference to FIGS. 6-7, detailed below.

FIG. 6 depicts a schematic representation of a service detector pipeline of a service detector/enricher, such as depicted and described with reference to FIG. 5. Specifically, the system 600 is a service detector pipeline 602, which may be configured to operate in much the same manner as the service detector pipeline 510 of FIG. 5 and/or the data ingester 416 of FIG. 4A. As noted above, the service detector pipeline 602 can receive input and can provide output as a part of a data processing operation of a blackbox analysis system such as described herein. Typically, the service detector pipeline 602 receives one or more results of a work performed by an ephemeral node, such as described above, and provides an output to another system, service, or subservice of a blackbox analysis system, such as described herein.

In particular, as noted above, the service detector pipeline 602 includes one or more purpose-configured data detectors, identified in the figure as the service detectors 604, 606, and 608. Each of the service detectors are configured to receive and/or process data input to the service detector pipeline 602 and, in response to receiving a threshold quantity or expected type of data, each is configured to output an indication that a service has been positively identified.

Output(s), if any, from the service detectors of the service detector pipeline 602 can be received in a queue, identified in the figure as the detection queue 610. The detection queue can be configured to receive results from the service detectors asynchronously and to provide outputs to other systems of the blackbox analysis system in first-in-first-out manner.

In some examples, the service detectors of the service detector pipeline 602 can be operated in parallel and asynchronously with respect to each other, although such an architecture is not required. In other examples, each individual service detector can be executed individually in a sequence. In still other examples, different service detectors may be clustered, arranged in a hierarchy, or otherwise executed in an intentional order to optimize processing through the service detector pipeline 602.

It may be appreciated that the foregoing described construction is simplified and is not exhaustive of all implementations or architectures that may be used to detect services and/or to provide service suggestions, such as described herein.

FIG. 7 depicts a schematic representation of a service suggestor pipeline of a service detector/enricher, such as depicted and described with reference to FIG. 5. Specifically, the system 700 is a service suggestor pipeline 702, which may be configured to operate in much the same manner as the service suggestor pipeline 508 of FIG. 5, the service suggestor 424, and/or the service enricher 428 of FIG. 4A.

As noted above, the service suggestor pipeline 702 can receive input and can provide output as a part of a data processing operation of a blackbox analysis system such as described herein. As with the service detector pipeline described in reference to FIG. 6, typically, the service suggestor pipeline 702 receives one or more results of a work performed by an ephemeral node, such as described above, and provides an output to another system, service, or subservice of a blackbox analysis system, such as described herein. The service suggestor pipeline 702 is configured to output a suggestion such as, but not limited to: a new service to research; an existing service to update; an existing service to remove; a new class of service to research; and so on.

In particular, as noted above, the service suggestor pipeline 702 includes one or more purpose-configured data detectors, identified in the figure as the property detectors 704, 706, and 708. Each of the property detectors are configured to receive and/or process data input to the service suggestor pipeline 702 and, in response, output a specific or well-formatted representation of a data item that may be of interest. Examples include, but are not limited to: version numbers; software names; closed or open port lists; response timing; request latency; traceroute results; nmap results; IP addresses or ranges; MAC addresses or ranges; and so on.

Output(s), if any, from the property detectors of the service suggestor pipeline 702 can be received in a queue, identified in the figure as the property queue 710. The detection queue can be configured to receive results from the property detectors asynchronously and to provide outputs to other systems of the blackbox analysis system in a first-in-first-out manner and/or configured to store the results in a database, such as the data store 712.

As with the service detector pipeline 602 of FIG. 6, the property detectors of the service suggestor pipeline 702 can be operated in parallel and asynchronously with respect to each other, although such an architecture is not required. In other examples, each individual property detector can be executed individually in a sequence. In still other examples, different service detections may be clustered, arranged in a hierarchy, or otherwise executed in an intentional order to optimize processing through the service suggestor pipeline 702.

It may be appreciated that the foregoing described construction is simplified and is not exhaustive of all implementations or architectures that may be used to detect services and/or to provide service suggestions, such as described herein.

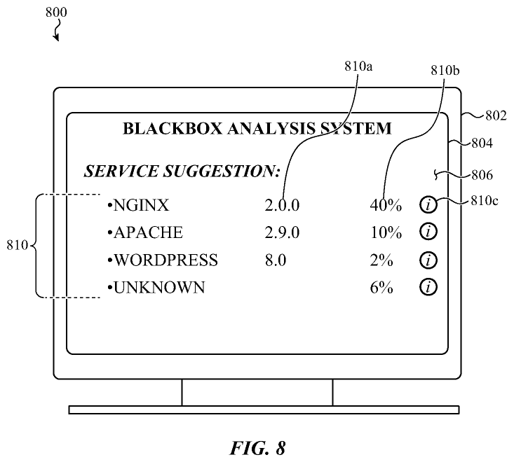

The output(s) provided by a service suggestor pipeline, such as described in reference to FIG. 7, can be communicated to a data analyst or operator of a blackbox analysis system using any suitable method. In one example, a user interface can be provided that can be used by a data scientist or analyst to interact with the blackbox analysis system. An example user interface is provided in FIG. 8.

Specifically, FIG. 8 depicts an example user interface that can be rendered by a client application executed by a client device configured to communicate with a system, such as shown in FIG. 1A, to provide suggestions to a data analyst. In the illustrated embodiment, a client device 800 includes a housing 802 that encloses and supports a display 804 that, in turn, is configured to render a graphical user interface 806. In this example, the graphical user interface 806 can be configured to render a table of suggested services 810 that indicates a service name, a service version (one of which is identified as the version 810a), a service occurrence metric 810b, and a more information request button 810c. Leveraging a user interface such as shown, a data analyst may be able to quickly triage which recognized or otherwise detectable services that do not currently have an associated exploit or other use purpose for a blackbox analysis system are worth investing time and/or research budget to further characterize.

Other user interfaces may be configured in other ways; it is appreciated that FIG. 8 provides a single example.

In view of the foregoing, it may be understood that these descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

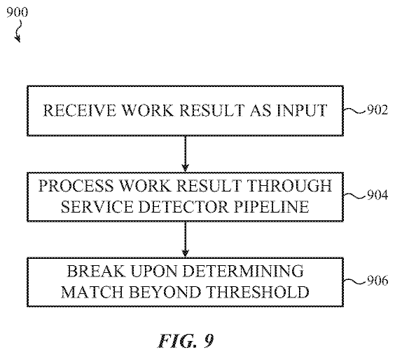

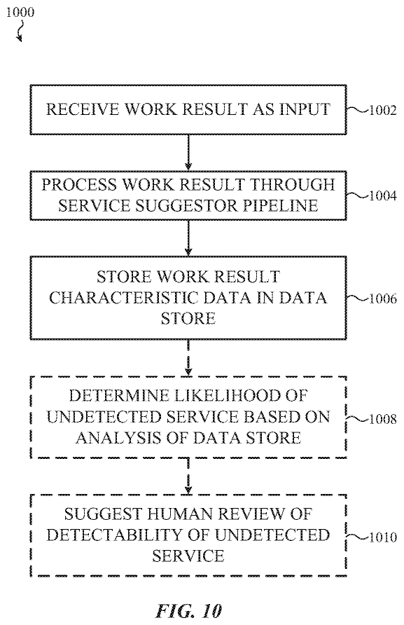

Generally and broadly, FIGS. 9-10 depict flowcharts showing example operations of methods of using and/or operating a system such as described herein. It may be appreciated that these methods are not exhaustive and that additional or alternative operations or steps may be required or may be suitable in certain implementations.

FIG. 9 is a flowchart depicting example operations of a method of operating a service detector, such as described herein. The method 900 can be performed in whole or in part by any component, module, processor (virtual or otherwise), such as described herein. The method 900 includes operation 902 at which a work result is received as input. Next, at operation 904, the received work result is processed with a service detector pipeline, such as described herein. The method 900 further includes operation 906 at which the pipeline and/or other processing operations are halted once a service match is determined.

FIG. 10 is a flowchart depicting example operations of a method of operating a service enricher, such as described herein. As with the method 900, the method 1000 can be performed in whole or in part by any suitable software or hardware such as described herein. The method 1000 includes operation 1002 in which a work result is received as input. Next at operation 1004, the work result is processed through a service suggestor pipeline, such as described herein. Next, at operation 1006, the results of processing can be stored in a database, such as a property or characteristic database. Optionally, the method 1000 includes operations 1008 and 1010. The operation 1008 determines a likelihood that an undetected service exists based on data stored in the data store of operation 1006. Next, at operation 1010, human review may be suggested by the service suggestor.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources—only on informed consent of the subject of that data and/or information—should be accessed and aggregated only for legitimate, agreed-upon, and reasonable uses.

What is claimed is:

1. A server system for analyzing a result of a computational task targeting a remote address performed by a worker node instance selected from a pool of worker node instances, the server system comprising:
a memory allocation storing an executable asset; and
a processor allocation configured to access the executable asset from the memory allocation to instantiate a service detector instance configured to define:
an initial condition in which the computational task is a working computational task; and
an operating condition in which the service detector instance is configured to recursively:
retrieve a working result of the working computational task;
assemble a set of prediction data objects by providing the working result as input to a set of service detectors;
select from the set of prediction data objects, at least one prediction data object that comprises a respective statistical confidence exceeding a threshold;
select a next computational task based at least in part on the at least one prediction data object;
select a next worker node instance from the pool of worker node instances and assign the next computational task to the next worker node instance; and
redefine the operating condition of the service detector instance such that the next computational task is the working computational task.

2. The server system of claim 1, wherein in the operating condition the service detector instance is configured to assemble a set of prediction data objects by providing the working result as input to a set of service detectors, each configured to provide one of:
no output; or
a prediction data object.

3. The server system of claim 2, wherein each prediction data object comprises:
an identification of a probable software configuration; and
a statistical confidence that the remote address is associated with a computing resource configured according to the probable software configuration;

4. The server system of claim 1, wherein:
the server system is a distributed server system; and
the pool of worker node instances is remote to at least the processor allocation.

5. The server system of claim 1, wherein the remote address is accessible over the open Internet.

6. The server system of claim 5, wherein the remote address is accessible over a private network.

7. The server system of claim 1, wherein when in the operating condition, the service detector instance is configured to:
determine whether the set of prediction data objects is a null set, and in response to determining that the set of prediction data objects is a null set, ending recursion.

8. The server system of claim 1, wherein when in the operating condition, the service detector instance is configured to query a database to retrieve the working result.

9. The server system of claim 8, wherein the database is remote to the server system.

10. The server system of claim 8, wherein the database is managed by a worker manager instance configured to assign computational tasks to one or more worker node instances of the pool of worker node instances.

11. The server system of claim 1, wherein the computation task comprises a reconnaissance operation.

12. The server system of claim 9, wherein the reconnaissance operation comprises:
a subdomain enumeration operation;
an address resolution operation;
a remote resource request; or
a query to a third-party database.

13. The server system of claim 11, wherein the next computational task comprises an exploit of a vulnerability.

14. A method of distributing computational work to worker nodes of a pool of worker nodes of a system configured for remote discovery of a configuration of a remote computing resource, the method comprising:
selecting a computational task from a set of computational tasks to be performed by at least one worker node of the pool of worker nodes;
submitting a first request to the pool of worker nodes to execute the computational task by at least one worker node of the pool of worker nodes;
upon determining that the computational task has successfully executed, providing a result of the computational task as input to a detector service configured to output a statistical confidence that the remote computing resource is configured according to a particular software configuration;
selecting a next computational task from the set of computational tasks based on the particular software configuration; and
submitting a second request to the pool of worker nodes to execute the next computational task by at least one worker node of the pool of worker nodes.

15. The method of claim 14, wherein the computational task is performed by a different worker node than then next computational task.

16. The method of claim 14, wherein the computational task is selected based, at least in part, on an address associated with the remote computing resource.

17. A method of distributing computational work to worker nodes of a pool of worker nodes of a system configured for remote discovery of a configuration of a remote computing resource accessible at a remote address, the method comprising:
selecting a computational task to be performed by a worker node of the pool of worker nodes, the computational task selected based on a characteristic of the remote address;
defining the computational task as a selected computational task; and
recursively:
requesting to execute the selected computational task by at least one worker node of the pool of worker nodes;
obtaining a result of the computational task from a result database;
providing the result of the computational task as input to a detector service configured to output a statistical confidence that the remote computing resource is configured according to a particular software configuration;
upon determining that the statistical confidence exceeds a threshold, selecting a next computational task to be performed by a worker node of the pool of worker nodes, the computational task selected based on the particular software configuration; and
defining the next computational task as the selected computational task.

18. The method of claim 17, upon determining that the statistical confidence does not exceed the threshold, flagging at least one of the remote computing resource, the remote address, or the computational task for review.

19. The method of claim 17, wherein the statistical confidence is stored in a confidence database.

20. The method of claim 17, upon determining that the statistical confidence does not exceed the threshold, flagging a software instance executing at the remote computing resource as an undetected software instance.
